(19) United States
(12) Patent Application Publication
(10) Pub. No.: US 2006/0091203 A1
(43) Pub. Date: May 4, 2006

(54) Systems and methods for the identification and presenting of information

(76) Inventors: Anton Bakker, Norfolk, VA (US); Marc L. Allen, Chesapeake, VA (US)

Correspondence Address: NIXON PEABODY, LLP, 401 9TH STREET, NW, SUITE 900, WASHINGTON, DC, 20004-2128, US

(21) Appl. No.: 11/247,980

(22) Filed: Oct. 12, 2005

Related U.S. Application Data
(63) Continuation-in-part of application No. 10/840,614, filed on May 7, 2004.
(63) Continuation-in-part of application No. 10/137,375, filed on May 3, 2002, now Pat. No. 6,869,013.
(63) Continuation-in-part of application No. 10/840,615, filed on May 7, 2004.
(63) Continuation-in-part of application No. 10/137,375, filed on May 3, 2002, now Pat. No. 6,869,013.
(63) Continuation-in-part of application No. 10/396,499, filed on Mar. 26, 2003, now abandoned.
(63) Continuation-in-part of application No. 10/863,284, filed on Jun. 9, 2004.
(63) Continuation-in-part of application No. 10/428,046, filed on May 2, 2003, now abandoned.
(63) Continuation-in-part of application No. 10/648,443, filed on Aug. 27, 2003.
(63) Continuation-in-part of application No. 10/648,442, filed on Aug. 27, 2003.
(63) Continuation-in-part of application No. 11/065,077, filed on Feb. 25, 2005.
(60) Provisional application No. 60/468,252, filed on May 7, 2003.
(60) Provisional application No. 60/288,329, filed on May 4, 2001.
(60) Provisional application No. 60/468,646, filed on May 8, 2003.
(60) Provisional application No. 60/468,941, filed on May 9, 2003.
(60) Provisional application No. 60/367,493, filed on Mar. 27, 2002.
(60) Provisional application No. 60/477,756, filed on Jun. 12, 2003.
(60) Provisional application No. 60/377,589, filed on May 6, 2002.
(60) Provisional application No. 60/406,050, filed on Aug. 27, 2002.
(60) Provisional application No. 60/406,048, filed on Aug. 27, 2002.
(60) Provisional application No. 60/406,049, filed on Aug. 27, 2002.

(51) Int. Cl. G06F 7/08

(52) U.S. Cl. 235/381

(57) ABSTRACT

A method, system and computer readable medium for presenting information for use within a gas station, including sensing at the gas station at least an identification code on one or more identification-carrying devices; receiving at least the identification code and information presentation system identification information at an information server; determining one or more portions and type of information to be presented on an information presentation system at the gas station based on the identification code and the information presentation system identification information; receiving and printing at the gas station the one or more portions of information presented at the information presentation system; and storing on a template storage device one or more templates that are combinable with the one or more portions of information.

### CROSS REFERENCE TO RELATED DOCUMENTS

The present invention is a Continuation-in-Part Patent Application of commonly-assigned, co-pending (i) U.S. patent application Ser. No. 10/840,614 of ALLEN, filed May 7, 2004, entitled “METHOD AND SYSTEM FOR INFORMATION DISPLAY USING A MULTIMEDIA DEVICE EMPLOYING A POWERLINE MODEM,” now pending, which claims benefit of priority to U.S. Provisional Patent Application Ser. No. 60/468,252, filed May 7, 2003, entitled “POWERLINE RFID MEDIA DEVICE,” and which is a Continuation-in-Part Patent Application of U.S. patent application Ser. No. 10/137,375, filed May 3, 2002, entitled “SYSTEM AND METHODS FOR THE IDENTIFICATION AND DISPLAYING OF INFORMATION,” now U.S. Pat. No. 6,869,013, which claims benefit of U.S. Provisional Patent Application Ser. No. 60/288,329, filed May 4, 2001, entitled “CUSTOMER IDENTIFYING COUPON PRINTER,” (ii) U.S. patent application Ser. No. 10/840,615 of BAKKER et al., filed May 7, 2004, entitled “METHOD AND SYSTEM FOR PROVIDING INCENTIVES BASED ON A PAYMENT TYPE,” now pending, which claims benefit of priority to U.S. Provisional Patent Applications Ser. No. 60/468,646, filed May 8, 2003, entitled “INCENTIVE PAYMENT,” and No. 60/468,941, filed May 9, 2003, entitled “INCENTIVE PAYMENT,” and which is a Continuation-in-Part Patent Application of U.S. patent application Ser. No. 10/137,375, filed May 3, 2002, entitled “SYSTEM AND METHODS FOR THE IDENTIFICATION AND DISPLAYING OF INFORMATION,” now U.S. Pat. No. 6,869,013, which claims benefit of U.S. Provisional Patent Application Ser. No. 60/288,329, filed May 4, 2001, entitled “CUSTOMER IDENTIFYING COUPON PRINTER,” (iii) U.S. patent application Ser. No. 10/396,499 of BAKKER, filed Mar. 26, 2003, entitled “CUSTOMER ACQUISITION IN A LOYALTY SYSTEM,” now pending, which claims benefit of priority to U.S. Provisional Patent Application Ser. No. 60/367,493, filed Mar. 27, 2002, entitled “AUTOMATIC CUSTOMER ACQUISITION IN A LOYALTY SYSTEM,” (iv) U.S. patent application Ser. No. 10/863,284 of BAKKER et al., filed Jun. 9, 2004, entitled “SYSTEM AND METHOD FOR PROVIDING INCENTIVES BASED ON RECEIPT SNIFFING,” now pending, which claims benefit of priority to U.S. Provisional Patent Application Ser. No. 60/477,756, filed Jun. 12, 2003, entitled “RECEIPT SNIFFING INCENTIVES,” and which is a Continuation-in-Part Patent Application of U.S. patent application Ser. No. 10/428,046, filed May 2, 2003, entitled “SELF-CONTAINED ELECTRONIC LOYALTY SYSTEM,” which claims benefit of U.S. Provisional Patent Applications Ser. No. 60/377,589, filed May 6, 2002, entitled “SELF CONTAINED ELECTRONIC LOYALTY SYSTEM,” and which is related to U.S. patent application Ser. No. 10/137,375, filed May 3, 2002, entitled “SYSTEMS AND METHODS FOR THE IDENTIFICATION AND DISPLAYING OF INFORMATION,” now U.S. Pat. No. 6,869,013, and U.S. patent application Ser. No. 10/396,499, filed Mar. 26, 2003, entitled “AUTOMATIC CUSTOMER ACQUISITION IN A LOYALTY SYSTEM,” (v) U.S. patent application Ser. No. 10/648,443 of BAKKER et al., filed Aug. 27, 2003, entitled “GENERIC LOYALTY TAG,” now pending, which claims benefit of priority of U.S. Provisional Patent Application Ser. Nos. 60/406,050, filed Aug. 27, 2002, entitled “GENERIC LOYALTY TAG,” and 60/406,048, filed Aug. 27, 2002, entitled “GASOLINE CONVENIENCE STORE RETAIL LOYALTY POINT SYSTEM,” and (vi) U.S. patent application Ser. No. 10/648,442 of BAKKER et al., filed Aug. 27, 2003, entitled “INTERACTIVE RETROFIT CAPABLE LOYALTY DEVICE,” now pending, which claims benefit of priority to U.S. Provisional Patent Application Ser. No. 60/406,049, filed Aug. 27, 2002, entitled “INTERACTIVE RETROFIT-CAPABLE LOYALTY DEVICE,” and is related to (vii) U.S. patent application Ser. No. 11/065,077 of BAKKER et al., filed May 25, 2005, entitled “SYSTEMS AND METHODS FOR THE IDENTIFICATION AND PRESENTING OF INFORMATION,” now pending, the entire disclosures of all of which are hereby incorporated by reference herein.

### FIELD OF THE INVENTION

The present invention generally relates to the displaying of information, and more particularly to a method and system for the identification and displaying of information based at least on an identification code.

### DISCUSSION OF THE BACKGROUND

In recent years, multimedia devices have become popular as mini advertising and information kiosks. They entertain and interact with customers, particularly those in a captive situation, such as waiting in line for groceries, purchasing tickets, or filling a gasoline tank at a service station.

Also, with the advent of computerized point of sale terminals, loyalty systems have been incorporated with point of sale terminals and loyalty systems in order to dispense a reward to customers for frequent use of a company's services, frequent purchases of a company's goods, and the like. Frequent flyer miles are a prime example of how airlines reward passengers for traveling on their airline. The reward, based on the number of “miles” accumulated, can vary from discounts on future airline ticket purchases, to seat upgrades, free tickets, and the like.

Likewise, grocery stores often implement a coupon-printing scheme whereby customers are given a coupon that is redeemable for future purchases after purchasing a particular product. For example, during scanning of a particular brand of tooth paste at the checkout counter, a printer associated with the cash register, produces a coupon redeemable against the next purchase of a related mouthwash product. In this example, the triggering event for the printing of the coupon is the scanning, i.e., purchase, of a particular product. However, the generation of this coupon is independent of the identity and preferences of the user, or customer. For example, the user may not use mouthwash. Therefore, the printing of that particular coupon did not accomplish its intended purpose, the sale of another related product.

Retail stores computerized inventory systems are usually integrated with point-of-sale terminals for automatic updating of inventory. Inventory systems are known to be continuously connected to a central master system via for example LAN and WAN, using leased optical or non-optical lines, satellite transceiver, DSL, cable, etc. Inventory systems are also known to connect to a central master system on a periodic basis via a telephone modem. However, associated with these known systems are relatively high cost of installation of networking equipments, which may include expensive cable installations.

In addition to the above-mentioned loyalty systems, customer loyalty has been created by cash-back or points reward programs designed by credit or charge card issuers to encourage card holders to use their credit or charge cards (hereafter credit cards) to pay for purchases. If a customer uses a credit card with such a reward program, he/she may typically earn from 1% to 1.5% of the total amount spent, or he/she may earn a number of points based on the amount of money spent. The reward is usually given at the end of each credit or charge card billing cycle. If the reward is monetary, the amount of money earned as a reward is subtracted from the total card balance. If the reward is points-based, the points are accrued until there are enough to trade the bonus points for a gift.

While these types of incentive are usually of benefit to card users, they are generally not beneficial to retailers accepting credit card payments. This is generally due to the increased costs realized by merchants in the back-end processing required for credit card transactions. In order to provide the convenience and security of cashless payments to customers, retailers commonly provide options for paying with credit cards at no additional mark-ups to the merchandise sold. That is, whether payment is received in the form of cash or credit card, the prices of the same merchandises being sold are the same. The benefits of convenience and security for customers, however, are customarily provided by retailers who bear the expense of between 2% to 4.5% or more per purchase transaction which is charged by credit card companies to process credit card payments.

In view of the above, there is a need for a system and method for incentivizing customers to pay with cash which would create a win-win result for both the customers as well as retailers who can reduce their overheads by reducing usage fees paid to credit card companies.

Loyalty systems reward a customer for frequent use of a company's services, frequent purchasing of a company's goods, and the like. For example, frequent flyer miles are a prime example of how air lines reward passengers for traveling on their particular airline. The reward, based on a number of “miles” accumulated can vary from discounts on future airline tickets, to seat upgrades, to free tickets, and the like.

Loyalty systems are becoming more popular as a retail mechanism for obtaining and retaining customers. Before employing a loyalty system, a retailer must decide if the benefits outweigh the costs. One of the most significant costs is that of customer acquisition.

Customer acquisition is the process of convincing a current or potential customer to become a participating loyalty member. This is often done using the traditional advertising techniques of flyers, mailers, in-store literature, posters, and/or radio, television or print advertisements. Theses techniques can be extremely expensive, which has a direct impact of the overall return of the loyalty system. If the cost to acquire the customer as a member is more than the retailer could earn from that customer, it defeats the point of having a loyalty system in the fist place.

Loyalty systems have existed in many forms, from simple punch card applications to large-scale electronic systems designed to interface with, for example, grocery store systems. However, current loyalty systems are generally price dependent and vary greatly in terms of their data gathering capabilities. For example, inexpensive systems typically use a manual entry device to enter specific data required to issue loyalty points or rewards. Such devices are typically limited to transaction or quantity totals, but provide little additional functionality. Furthermore, these systems are incapable of assisting the retailer in determining how well the actual loyalty system is performing, or which types of consumers are purchasing which types of products.

Alternative systems provide excellent data gathering capabilities, however they only operate in conjunction with a small set of, for example, point-of-sale register systems. Thus, retailers with multiple locations using different register systems, such as gas stations, are often unable to use a single loyalty system for all stations. For other systems, it is difficult to integrate the new loyalty system with perhaps older cash register or point-of-sale systems. Thus, it is not only necessary to purchase a loyalty system, but also a new cash register system to install many current loyalty systems.

Loyalty systems have existed in many forms, from simple punch card applications to large-scale electronic systems designed to interface with, for example, grocery store systems. Typically, a customer registers with a loyalty system and in turn receives a loyalty tag, i.e., identification device, associated with that particular system. Thus, to accumulate loyalty rewards, in conjunction with each purchase of a good or service, the customer uses their loyalty tag to identify themselves to the system thereby allowing the accumulation of points, rewards, and the like.

However, as loyalty programs are becoming increasingly more popular for frequent flyer programs, retail locations, gas stations, grocery stores, and the like, loyalty program members are increasingly found carrying multiple loyalty membership identification devices. For example, a loyalty program member may have a specific loyalty tag for a chain of gas stations, and another loyalty tag for a grocery store, and one or more loyalty tags associated with the airlines they most frequently fly on. Carrying multiple identification devices present multiple problems ranging from having multiple loyalty tags for the end user, limited compatibility between loyalty programs, cross marketing, and the like.

Likewise, loyalty systems traditionally reward customers for their loyalty based on purchases. Typically the loyalty system is point-based and linked to the total number of dollars spent. For example, in a convenience store environment, the purchases include fuel purchases and non-fuel purchases. A loyalty system that rewards fuel sales and non-fuel item sales in the same way based on the dollars spent presents a problem since, for example, the margin on sales of fuel and non-fuel items vary vastly. For example, a typical non-fuel sale may have 30% gross margin whereas a typical fuel sale may have a 9% gross margin.

### SUMMARY OF THE INVENTION

Therefore, there is a need for a method and system that addresses the above and other problems, such as by the exemplary embodiments of the present invention. Accordingly, in exemplary aspects of the present invention there is provided a system, method, and computer program product for presenting information for use within a gas station, including sensing at the gas station at least an identification code on one or more identification-carrying devices; receiving at least the identification code and information presentation system identification information at an information server; determining one or more portions and type of information to be presented on an information presentation system at the gas station based on the identification code and the information presentation system identification information; receiving and printing at the gas station the one or more portions of information presented at the information presentation system; and storing on a template storage device one or more templates that are combinable with the one or more portions of information

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is a functional block diagram illustrating an exemplary embodiment of the information display system according to this invention;

FIG. 2 is a flowchart illustrating an exemplary method of displaying information according to this invention;

FIG. 3 is a flowchart illustrating an exemplary method of selecting information according to this invention;

FIG. 4 is a flowchart illustrating an exemplary method of managing an account according to an exemplary embodiment of this invention;

FIG. 5 is a functional block diagram illustrating another exemplary embodiment of the information display system with powerline modem interface according to this invention;

FIG. 6 is a functional block diagram illustrating an exemplary embodiment of the information display device used in providing incentive for cash payment of the present invention;

FIG. 7 is a flowchart illustrating an exemplary method providing an incentive to make a cash payment for a purchase transaction using the system of FIG. 6;

FIG. 8 is a functional block diagram illustrating another exemplary embodiment of the information display device used in providing incentive for cash payment of the present invention;

FIG. 9 is a flowchart illustrating an exemplary method for providing an incentive for making a cash payment for a purchase transaction using the system of FIG. 8;

FIG. 10 is a functional block diagram illustrating an exemplary customer acquisition system;

FIG. 11 is a screen shot of a exemplary graphical user interface that can be used to program the customer acquisition system;

FIG. 12 is a flowchart illustrating an exemplary method for interfacing with a customer;

FIG. 13 is a flowchart illustrating a further exemplary method for interfacing with a customer;

FIG. 14 is a functional block diagram illustrating an exemplary loyalty system;

FIG. 15 is a detailed functional block diagram of an exemplary tag;

FIG. 16 is a detailed block diagram of an exemplary loyalty module;

FIG. 17 is a flowchart illustrating the exemplary operation of the loyalty module;

FIG. 18 is a functional block diagram illustrating the exemplary operation of a tag;

FIG. 19 is a functional block diagram illustrating another exemplary embodiment of a loyalty system;

FIG. 20 is a detailed block diagram of an exemplary sniffer module according to the embodiment illustrated in FIG. 19; and

FIG. 21 is a functional block diagram illustrating the exemplary operation of a sniffer module in FIGS. 19 and 20;

FIG. 22 is functional block diagram illustrating an exemplary loyalty system;

FIG. 23 is a detailed functional block diagram of an exemplary loyalty module;

FIG. 24 is a flowchart outlining an exemplary method for managing loyalty tags and rewards;

FIG. 25 is functional block diagram illustrating an exemplary loyalty network;

FIG. 26 is a detailed functional block diagram of an exemplary loyalty system;

FIG. 27 is a flowchart outlining the exemplary operation of the loyalty network;

FIG. 28 is functional block diagram illustrating an exemplary loyalty network in a retail store environment;

FIG. 29 illustrates exemplary consumer and product devices of FIG. 28;

FIG. 30 is functional block diagram illustrating another exemplary loyalty network in a retail store environment;

FIGS. 31-32 are flowcharts outlining the exemplary operation of the loyalty network in a retail environment;

FIG. 33 is functional block diagram illustrating an exemplary lighting based communications network;

FIG. 34 illustrates exemplary devices of the lighting based communications network of FIG. 33;

FIG. 35 is functional block diagram of an exemplary lighting based communications device of FIGS. 33-34; and

FIG. 36 is functional block diagram of further details of the lighting based communications device of FIG. 35.

### DETAILED DESCRIPTION OF THE PREFERRED EMBODIMENTS

The exemplary embodiments will be described in relation to methods and systems for presenting information for use within a retail environment, such as a gas station, a retail store, a convenience store, and the like. However, in order to avoid unnecessarily obscuring the present invention, the following description omits well-known structures and devices that may be shown in block diagram form or otherwise summarized. For the purpose of explanation, numerous specific details are set forth in order to provide a thorough understanding of the present invention. It should be appreciated, however, that the present invention may be practiced in a variety of ways beyond the specific details set forth herein.

U.S. patent application Ser. No. 10/840,614, incorporated by reference herein, addresses a need for an information display system used, for example, in a loyalty system, to provide information, such as coupons, based on user loyalty, purchasing habits, personal preferences, and the like. In particular, U.S. patent application Ser. No. 10/840,614 addresses a need for integration of the information display system with a central information server or related systems that offers the right balance of cost, convenience and speed without using the aforementioned connection methods. In order to provide a cost-effective, convenient, and sufficiently high speed system and method for a multimedia device for merchandising which interfaces with a central coordination device, in an exemplary embodiment, a powerline modem is advantageously combined with the multimedia device and a central coordination device.

In an exemplary aspect of U.S. patent application Ser. No. 10/840,614 there is provided a method and system of displaying information, including sensing at least an identification code on one or more identification-carrying devices; using a powerline modem to transmit the identification code and information display system identification information from information display system to an informational server; receiving at least the identification code and the information display system identification information at the information server; determining one or more portions of information to be displayed on an information display system based on the identification code and the information display system identification information; and receiving via the powerline modem and conveying the one or more portions of information at the information display system.

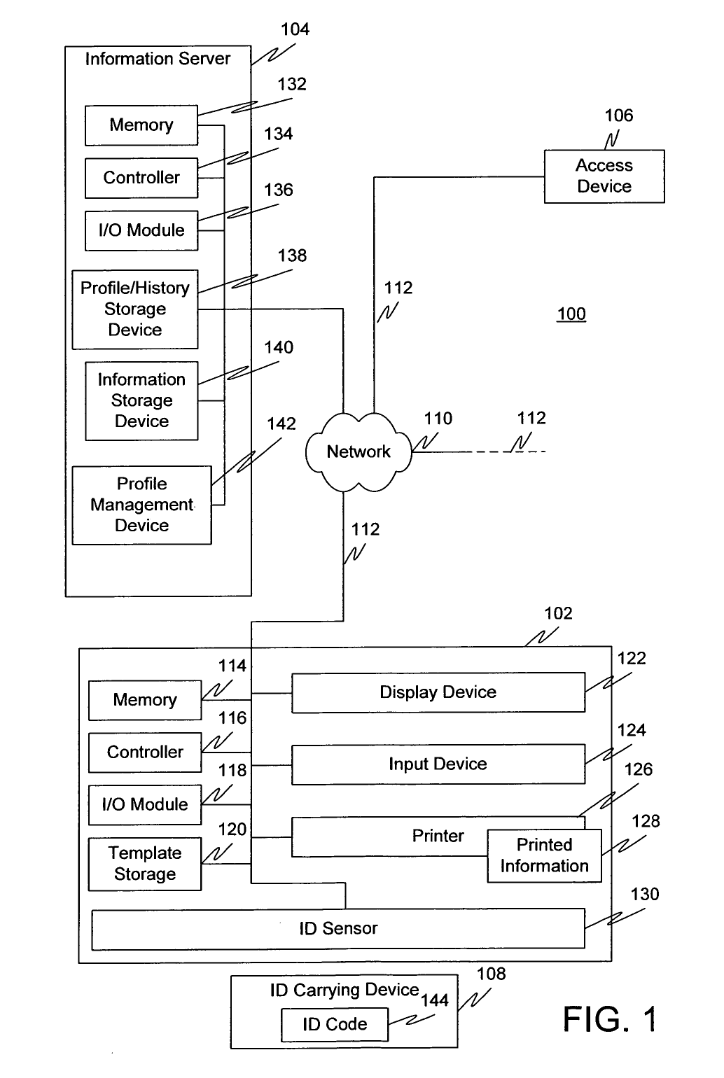

Referring now to the drawings, wherein like reference numerals designate identical or corresponding parts throughout the several views and more particularly to FIG. 1 thereof, there are illustrated an exemplary information display system 100. In FIG. 1, the exemplary information display system 100 can include an information display device 102, an information server 104, and an access device 106, for example, interconnected by a network 110 and one or more links 112. The information display device 102 can include a memory 114, a controller 116, an I/O module 118, a template storage device 120, a display device component 122, an input device 124, a printer 126 that outputs printed information 128, and an identification sensor (ID sensor) 130. The information display device 102 further communicates with an identification-carrying device 108 that stores one or more identification codes 144.

The information server 104 can include a memory 132, a controller 134, an I/O module 136, a profile and history storage device 138, an information storage device 140, and a profile management device 142.

Using the system of FIG. 1, an individual can identify themselves to an information display device, such as a coupon printer, using, for example, an identification-carrying device that includes a unique identification code. The identification code is associated with a particular profile that identifies, for example, customer loyalty, preference and history data that may be associated with a particular user. An identification sensor senses the identification code on the identification-carrying device. The identification code is then forwarded via, for example, a local information display device, to an information server. The information server uses the identification code, and possibly additional information such as an identification of the information display device, to access loyalty and preference data associated with the identification code. This information can include, for example, coupons that have been issued to the user associated with the identification code, a user's preferences, a user's purchase history, and the like.

Based on one or more of the above, the information server determines and forwards information, such as coupon information, back to the information display device which can then, for example, print the coupon for the user. The information can be, for example, anything from coupon parameters used to create a coupon to a fully formatted coupon ready for immediate printing. For example, the information display device, which can include a coupon printer, may be separate from any other suitable form of customer interaction, such as point-of-purchase terminals, gasoline dispensers, ATM's, and the like. Thus, while the information can be associated with a particular user interaction, the information can, for example, also be independent of any suitable transactions that may have occurred at the same location.

While the exemplary embodiments illustrated herein show the various components of the information display system collocated, it is to be appreciated that the various components of the information display system can be located at distant portions of a distributed network, such as a local area network, a wide area network, a telecommunications network, an intranet and/or the Internet, or within a dedicated information display system. Thus, it should be appreciated that the components of the information display system can be combined into one or more devices or collocated on a particular node of a distributed network, such as a communications network. As will be appreciated from the following description, and for reasons of computational efficiency, the components of the information display system can be arranged at any suitable location within a distributed network without affecting the operation of the system.

Furthermore, it should be appreciated that the various links connecting the elements can be wired or wireless links, or any suitable combination thereof, or any other suitable know or later developed element(s) that is capable of supplying and/or communicating data to and from the connected elements. Additionally, the term module as used herein, denotes any suitable piece of hardware, software, or combination thereof is capable of performing the functions associated with that element.

In operation, the identification-carrying device 108 is placed within the sensible area of the identification sensor 130. Upon the identification sensor 130 sensing one or more identification codes stored within the identification-carrying device 108, the information display device 102 forwards the one or more identifications, as well as any other suitable relevant information, to the information server 104. The information server 104 determines, for example based on the one or more identifications and, for example, an identification of the information display device 102, the information, if any, to be returned to the information display device 102 for display. Upon having made the determination, the information server 104 forwards to the information display device 102 all, a portion, or an identifier of information to be displayed on the information display device 102. The information display device 102 then displays the information, for example, on the display device component 122 and/or prints the information 128 on the printer 126.

The identification-carrying device 108 can be any suitable device that is capable of communicating with the identification sensor 130 in order to transfer information, such as the one or more identification codes 144, to the identification sensor 130. For example, the identification-carrying device 108 can communicate with the identification sensor 130 via a direct contact system, such as a magnetic strip and the identification sensor 130 a magnetic strip reader, an optical communication system, a radio frequency communication system or any other suitable known or later developed electrical, inductive or capacitive based system that is capable of communicating the identification code to the identification sensor 130.

For example, the identification-carrying device 108 can be based on RFID (radio frequency identification), which typically operates in the frequency range of 60 KHz to 5.8 GHz. Common identification-carrying devices 108 operate at 900 KHz, 125 KHz, 13.56 MHz and 2.4 GHz. Examples of direct contact systems can include the smartcard technology, magnetic strip readers, and the like. Optical systems can include, for example, barcode readers. Additionally, the identification-carrying device 108 can be integrated into a portion of a larger device, such as a wand or tag connected to a key chain. Examples of these devices are the Texas Instruments™. RFID tags, called “TIRIS”, the Phillips™. RFID tags, called “Mifair”, OTI RFID tags, Dallas Semiconductor's™ I-Button, and the like. Examples of smartcards, such as those produced by Schlumberger can also be used.

Alternatively, the identification-carrying device 108 can be a device that is capable of being written to as well as read from. For example, while the exemplary embodiments discussed below illustrate an embodiment where the user profile is stored on the information server 104, it is to be appreciated that it is also possible to store one or more portions of a user's profile on the identification-carrying device, or on a combination of the information server 104 and the identification-carrying device 108.

Upon the identification-carrying device 108 being placed in the sensible area of the identification sensor 130, the identification code 144 is read from the identification-carrying device 108 and forwarded, with the cooperation of the I/O module 118, the controller 116 and the memory 114, via network 110 and links 112, to the information server 104. Furthermore, the information display device 102 can supplement the identification code 144 code with additional information, such as the identifier of the information display device 102, the local time, whether any suitable goods and/or services were purchased, an identification of those goods/services, local weather information, or in general any suitable information that may be useful in terms of determining the information, if any, to be returned to the information display system 102. For example, if it is raining a coupon for a car wash is probably not appropriate.

Upon the information server 104 receiving the identification code and one or more additional portions of information, the information server 104 determines, with the cooperation of the memory 132, the controller 134, the I/O module 136, and the profile storage device 138, the type of information, if any, to be returned to the information display device 102. For example, the profile storage device 138 can be used to make the determination based on the current transaction, a history of transactions associated with the particular identification code, a reward based system such as the “frequent flyer miles” program, a promotion based on a customer loyalty program, and the like.

Upon determining the type of information to be forwarded to the information display device 102, the profile storage device 238 cooperates with the information storage device 140, as well as the memory 132, the controller 134, and the I/O module 136, to retrieve and forward the selected information to the information display device 102. For example, the information storage device 140 can include information, such as printable coupons, multi-media presentations, an identification and populatable portions of a template, audio and/or video clips, and the like, which is forwarded for subsequent display and/or printing at the information display device 102. Alternatively, the profile storage device 138 can forward an identifier to the information display device 102. This identifier corresponds to one or more types of information stored on the information display device 102 that can be displayed to, for example, a user.

Upon receipt of the information, or an identification of the information to be displayed, the information is displayed at the information display device 102 in cooperation with the memory 114, the controller 116, the I/O module 118, and if appropriate, the template storage 120. For example, based on the type of information, the information display device 102 determines one or more appropriate devices for displaying the information. For example, multimedia information can be displayed on the display device component 122. Alternatively, information, such as coupons, can be displayed on the display device component 122 and printed via the printer 126.

In addition to being able to display information, the information display device 102 can allow a user to interact with one or more of the information display device 102 and the information server 104 via the input device 124. While the input device 124 is shown as a separate component, it is to be appreciated that, for example, the display device component 122 and the input device 124 can be combined into one element, such as a touch screen, and the like. Alternatively, the input device 124 can be independent buttons such as, a “yes” and “no” buttons, and the like. Additionally, the input device 124 can be speech activated and based on, for example, speech recognition and a voice driven menu and selection system, and the like.

Therefore, there are at least three modes of operation for the information display device 102. In a first mode, information is directly printed via the printer 126. In a second mode, and for example in conjunction with the display device component 122, the user is prompted as to whether they would like to receive a print-out of selected information. For example, a preview of the information available to the user can be shown on the display device component 122. If the user decides to receive a print-out of the information, the user selects, via a print button on input device 124, to print the information. Alternatively, the user can opt not to receive a print-out of the information and perhaps just view it on the display device component 122. Thirdly, and again in conjunction with the display device component 122 and the input device 124, the user can optional navigate through a variety of types of information that are available. If a printable version of the information is desired, the user can select, via the input device 124, to print that information. For example, if the information available to a user includes a coupon for a sandwich, a coupon for a car wash and coupon for a free gallon of gasoline, the user can select the coupon most appropriate for their needs.

The template storage device 120 is capable of storing one or more templates that can be used in association with the information server 104 for displaying information on one or more of the display device component 122 and the printer 126. For example, the template storage device 120 can store basic populatable coupon templates. Thus, the information server 104 can forward to the information display device 102 the information to be inserted into these templates. Then, with the cooperation of the controller 116 and the memory 114, the information from the information server 104 is merged with one or more templates in the template storage device 120 and displayed. The templates can include printer templates, audio templates, video templates and/or multimedia templates, and the like.

Aside from the functionality associated with the user obtaining specific information associated with a particular identification code, the systems and methods of this invention also allow a user to create, manage and/or update their user profile, via, for example, access device 106. In particular, a user's profile is stored in the profile storage device 138. In general, the profile storage device 138 can include any suitable information about a user based on, for example, their associated identification code. For example, the profile storage device 138 can maintain an account of loyalty and/or rewards programs, user preferences, history logs, or any other suitable information specific to a user.

A user accesses their profile with the access device 106. The access device 106 can be, for example, a computer, a PDA, a telephone, and the like. Alternatively, the access device 106 can be incorporated into the information display device 102. In general, the access device 106 allows a user to access, manage and manipulate one or more profiles stored in the profile storage device 138.

For example, and with the cooperation of the access device 106, a user enters their identification code, and, for example, a password. Upon authentication of the password, and in cooperation with the profile management device 142, the user is allowed to access portions of their profile. For example, the user can change their personal preferences regarding how they would like information to be displayed on the information display device 102. For example, a user can select that they always want have all available coupons printed, be queried whether they would like available coupons printed, to only show coupons for certain categories of goods, and the like. Furthermore, a user can access their profile to determine, for example, the number of points in a loyalty rewards program.

| Display | Printing | Advertising | History | Status |
|---|---|---|---|---|
| Preferences | Preferences | Preferences | Preferences | Preferences |
| Query Before | Print All Coupons | Show No | Remember All | Show Current |
| Displaying | | Advertising | Transactions | Rewards |
| | | | | “Points” |
| Display All | Print All Coupons | Show Advertising | Remember No | Do Not Show |
| Information | For X | For X | Transactions | Status |
| Only Show | Query Before | Only Show | Only Remember | Alert When |
| Multimedia | Printing | Advertising For | Transaction If | Award |
| | | Local Merchant(s) | Associated With | Threshold |
| | | | A Rewards | Reached |
| | | | Program | |
| Only Show | Print Coupon | | Forward Rewards | |
| Information | Only If Similar | | History at | |
| About X | Coupon | | Predetermined | |
| | Previously | | Interval to | |
| | Redeemed | | Destination | |
| Show News | Only Print | | | |
| Feed | Coupons That Are | | | |
| | Instantly | | | |
| | Redeemable | | | |
| Show Weather | Only Print | | | |
| Feed | Coupons That Are | | | |
| | Instantly | | | |
| | Redeemable For | | | |
| | Purchased | | | |
| | Product | | | |

A user can also review a history of, for example, the coupons they have printed, and the information they have viewed, and print reports detailing these transactions.

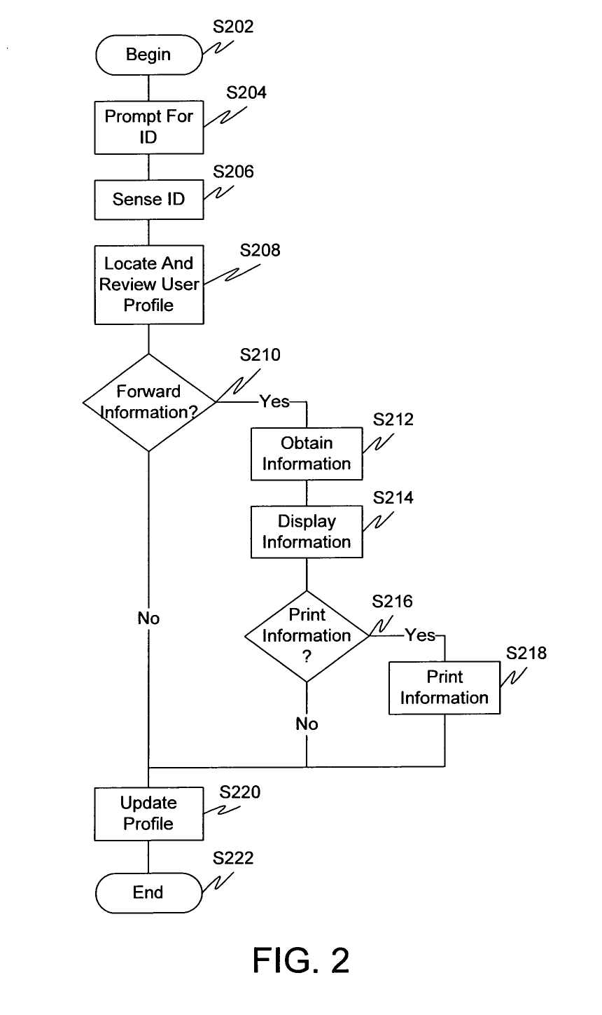

FIG. 2 outlines the exemplary operation of the information display system. In particular, control begins in step S202 and continues to step S204. In step S204, a user can optionally be prompted to place their identification-carrying device in the sensible area of the identification sensor. For example, the prompting can be based on an audio or video cue that could, for example, be triggered upon a user being within a certain proximity to an information display device. Next, in step S206, the identification code is sensed and retrieved from the identification-carrying device. Then, in step S208, the user profile, based on the sensed identification code is located and reviewed. Control then continues to step S210.

In step S210, a determination is made as to whether information should be forwarded to the user. For example, if the user profile specifies that the user would like to maintain a record of purchases for a rewards type system, but not receive any suitable coupons or printed information, control would jump directly to step S220. If information is to be forwarded to the user, control continues to step S212.

In step S212, the appropriate information, or an identification of the information to be displayed, is obtained. For example, as discussed above, the determination of the information to be displayed can be dynamically determined based one or more portions of information. Next, in step S214, the information is displayed. Then, in step S216, a determination is made whether all or a portion of the information should be printed. For example, as discussed earlier, the determination can be based on query to the user or, for example, based a user's profile, and the like. If the information is to be printed, control continues to step S218 where the information is printed. Alternatively, the information can be printed or forwarded to one or more alternative or additional locations. For example, the user can specify in their profile that only coupons that are instantly redeemable should be forwarded to the printer. Other information or coupons that, for example, are not instantly redeemable, could be forwarded via mail, electronic and/or hard copy, to a destination specified in the user's profile. Control then continues to step S220.

Alternatively, if there is no desire to print the information, control jumps to step S220. In step S220, the user's profile is optionally updated. For example, as discussed previously, a user's history can be updated so as to, for example, log customers loyalty points, record a user's transactions, and the like. Control then continues to step S222 where the control sequence ends.

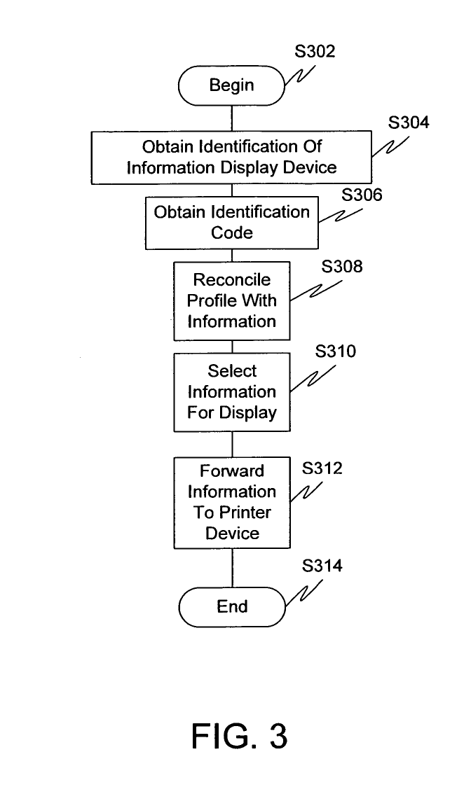

FIG. 3 outlines an exemplary method of selecting information according to this invention. In particular, control begins in step S302 and continues to step S304. In step S304, the identification code of the information display device can be optional obtained. For example, as discussed previously, in conjunction with the identification code of a user, the identification code for the information display device can also be used to aid in selecting the type of information to be presented to a user. Next, in step S306, the identification code is obtained.

In step S308, one or more of the information display device identification code and the identification code is reconciled with a user's profile information. Based on this reconciliation, in step S310, information is selected for display. Control then continues to step S312.

In step S312, the selected information is forwarded to the information display to be viewed, printed, and the like, by the user. Control then continues to step S314 where the control sequence ends.

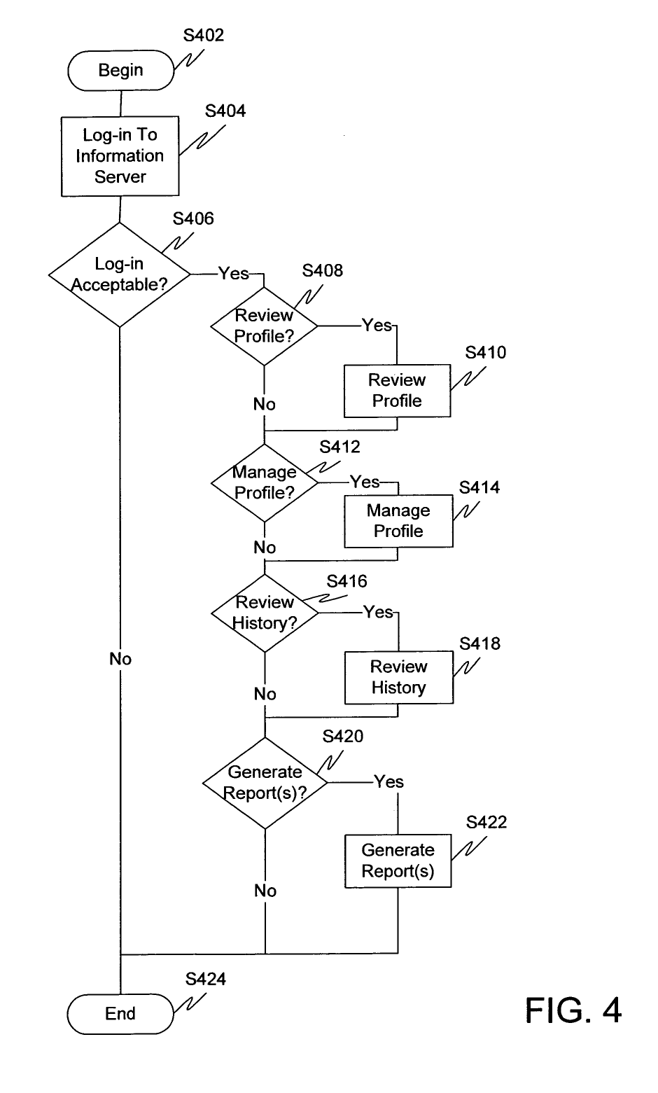

FIG. 4 outlines an exemplary method of accessing and managing a profile associated with an identification code according to an exemplary embodiment of this invention. In particular, control begins in step S402 and continues to step S404. In step S404 a user logs on to the information server. Next, in step S406, a determination is made as to whether the login was acceptable. If the login was acceptable, control continues to step S408. Otherwise, control jumps to step S424 where the control sequence ends.

In step S408, a determination is made as to whether the user would like to review their profile. If the user would like to review their profile, control continues to step S410 where a portion of the profile can be reviewed. Otherwise, control jumps to step S412. In step S412, a determination is made as to whether the user would like to manage their profile. If the user would like to manage their profile, control continues to step S414 where the used can modify/update a profile. Otherwise, control jumps to step S416.

In step S416, a determination is made as to whether the user would like to review their history. If the user would like to review their history, control continues to step S418 where the history can be reviewed, printed, and the like. Otherwise, control jumps to step S420.

In step S420, a determination is made as to whether the user would like to generate one or more reports. If the user would like to generate one or more reports, control continues to step S422 where the reports are generated. Otherwise, control jumps to step S424 where the controls sequence ends.

A typical loyalty system that could incorporate the above-described systems and methods of this invention could possible have other identification device readers associated with cash registers and gasoline dispensers, and the like, that are capable of accumulating loyalty and/or purchasing information that could also be assimilated with the systems and methods of this invention. For example, upon a user filling their car with fuel, the fuel pump loyalty system, cooperating with the systems and methods of this invention, could determine whether the user would desire a coupon for a car wash. Upon the systems and methods of this invention determining that the user received a coupon for a car wash yesterday that was redeemed, the system can determine if another type of coupon would be more appropriate, or determine that no coupon is necessary at this time. Alternatively, the system could query the user before the printing of the coupon to ensure that the coupon is desired.

For example, with the systems and methods of this invention, the user, such as a convenience store customer, is not necessarily required to accept any suitable information, such as coupons, that they may be eligible for simple because they identify themselves to the information display system. Instead, the customer is allowed to obtain the information that they desire at a time when they desire through one or more of preferences and an input device that can obtain feedback from the user.

This allows, for example, added versatility in terms of how and what types of information can be provided. Specifically, a coupon need not be printed at the location it is earned. Thus, for example, by having the loyalty, preference and purchasing data held at a central location, loyalty preferences can be tracked at any suitable location. For example, coupon printing can occur across many sites, such as in a chain of convenience stores. Many of the current loyalty systems either require the coupons to be printed at the moment they are earned or are created and maintained by an overall brand. Thus, these brand-based systems are location and brand specific.

In contrast, and in accordance with another exemplary advantage of this invention, the information display system can operate across a plurality of locations, for example, owned by a plurality of different entities, regardless of the brand association, or type of product and/or service sold.

The basic concepts associated with this invention can be expanded to be incorporated into identification sensing devices already present. For example, already existing identification sensors could forward and communicate with the information server according to the principles of this invention to allow a local printer or display device associated with the identification sensing device to print and/or display information, such as a coupon. For instance, a retail store's electronic cash register that supports RFID (Radio Frequency IDentification) may, for example, after having identified the customer, prompt the customer if they would like any available coupons, or a selected group of coupons, printed on the associated printer. Alternatively, the information, such as coupons, need not be physically printed, but an electronic version of the information, such as a coupon, can be forwarded and reconciled with, for example, an existing payment system.

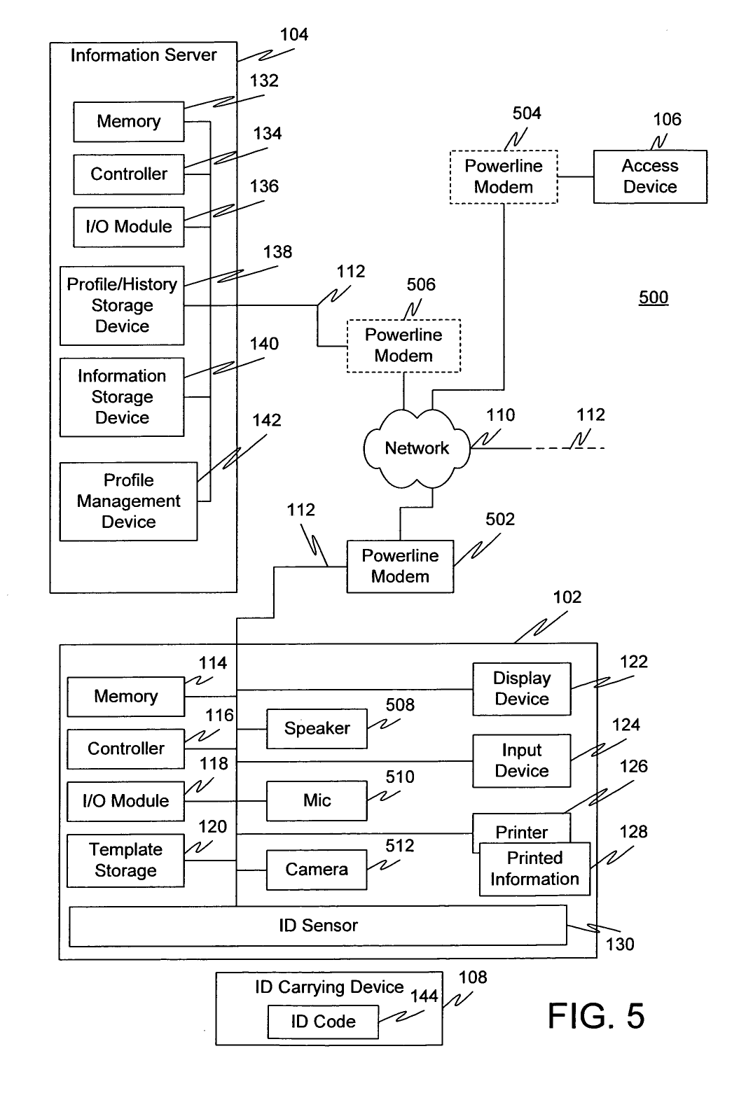

FIG. 5 illustrates a further exemplary system 500 according to an embodiment of the present invention. The embodiment illustrated in FIG. 5 includes a number of similar components found in the embodiment illustrated in FIG. 1 and discussed above. Therefore, for the sake of brevity and clarity, the similar features shared by both embodiments are shown with same numerical labels, and their descriptions are not repeated hereafter.

A powerline modem can include a device configured to modulate and demodulate data for digital bi-directional transmission over a common AC power line in the home, business, and electric power infrastructure. Powerline modems are capable of achieving a local data transmission rate of 100 Mbps, which is equal to many Ethernet LANs, and long-distance transmission rate of over 1 Mbps. Accordingly, a powerline can include any suitable devices capable of data transmission over electric power lines.

Using electrical lines and powerline modem, according to the exemplary embodiments, renders installation and service very convenient while achieving considerable cost-savings over aforementioned existing means as well as meeting the bandwidth requirement for audiovisual and data transmission. For example, there is no need for the bulky apparatus associated with wireless access. Connection between information display and a central coordinating device, for example, does not tie up phone lines like standard phone/modem connections, current implementations of cable TV services, or other phone line based services. Additionally, the system features constant access to the Internet, and much of the apparatus is already in place.

Further, in a typical wiring installation for connecting information display devices with a central coordinating device, for example, the cost of installing cables and associated hardware can add another 15-20% to the cost of the entire system, particularly in those locations where the kiosk or device is external to the primary facility, such as a gasoline station. Hence, this embodiment of the present invention as illustrated in FIG. 5 addresses the aforementioned problems.

As illustrated in FIG. 5, a powerline modem 502 is employed as a communication means between the information display device 102 and the information server 104. In FIG. 5, the information display device 102 interfaces with network 110 which in turn interfaces with information server 104, via a conventional communication means or via a powerline modem 506. To achieve similar cost-saving and convenience as in using powerline modems 502 and 506, powerline modem 504 can also be used to couple Access Device 106 to information Server 104 via Network 110.

Although various means can be employed for implementing a connection between various computers in a network, such as dedicated wired network, leased optical or non-optical line, satellite transceiver, etc., as previously described, using powerline modems allows the information display system of the present invention to interface with a central coordinating computer device system, while taking advantage of existing powerline infrastructure, as well as existing electrical wiring residences and businesses, advantageously, reducing the cost of installation.

The exemplary system 500 of FIG. 5 further includes the information display device 102 configured to employ audio speaker 508, microphone 510 and video camera 512. Motion sensing can be accomplished with video camera 512 to detect the presence of a customer, identify a customer, for example, by biometrics and facial recognition algorithm. Video camera 512 can also be utilized to control auto brightness of display device component 122 and sound. For example, based on the camera's sensed information, display component 122 can be put in a various modes, including, for example, brightness mode suitable for existing light conditions, or sleep-mode to reduce energy consumption and wear-and-tear.

Audio speaker 508 is used to deliver to a customer audio information separately or in conjunction with the information displayed on display device component 122. Audio information delivered can be for entertainment, such as music or advertisement, or informational, such as instructions, news, etc. Audio speaker 508 can be muted when no customer is present, or when a mute selection is selected by a user. Microphone 510 can be used to convey verbal communication between a customer and an operator, whether the operator can include a human being or a voice-recognition system.

With the incorporation of these audiovisual devices, real-time audio-visual information can be conveyed between customers and information server 104, a human operator (not shown), speech recognition system, and etc., associated with the operation of a business. The application of the audiovisual devices incorporated with the information display device 102 is not limited to the above-listed functions, but can be adapted to any suitable multimedia needs to the extent possible by programming their control and utilization.

Thus, the exemplary embodiments include employing a powerline modem in the integration of an information display device and a central coordination device, a multimedia information display for use in a loyalty system that includes a video display, a video camera, an audio speaker, a microphone, a printer, and an input device, presentation of specific data based on an identifier, such as an identification code, associated with a user and communicated between an information display device and a central coordination device via a powerline modem, printing of coupons and/or promotional material based on a sensed identification code, management of a profile associate with the identification code, management of a customer profile and preferences associated with a unique identification code which can, for example, be stored in an identification-carrying device, a coupon printer having an associated identification sensor for sensing an identification-carrying device, communicating user specific information to a centralized location via a powerline modem and determining display information based on the sensed identification code, determining presentation information based on a sensed identification code and an information display device identification, and the like. Advantageously, the exemplary embodiments minimize installation costs and help to provide a plug and play installation.

U.S. patent application Ser. No. 10/840,615, incorporated by reference herein, describes a system and method for providing an incentive for a purchase. More specifically, customers are provided with choices involving selecting cash payment or credit card payment and dispensing a reward or disincentive based on the customers' selection. An exemplary embodiment, advantageously, can be used, for example, in conjunction with a loyalty system to provide information, such as coupons, to a user, such as a customer, based on their loyalty, purchasing habits, personal preferences, and the like. Instead of a cash reward for cash payment, coupons can be provided for discounted future purchases or for free redemption of merchandise.

In an exemplary aspect of U.S. patent application Ser. No. 10/840,615 there is provided a method and system for providing an incentive for a type of payment, including displaying a message on an information display device prompting for selection of a payment type having an associated incentive for a transaction; determining a total sale of the transaction from a point-of-sale device; computing a reward to be conveyed based on the total sale and the associated incentive, if the payment type having the associated incentive is selected; and dispensing the reward.

The following exemplary embodiments will be described in relation to methods and systems for providing incentives, and more particularly to a system and method for providing incentives based on use of a payment type.

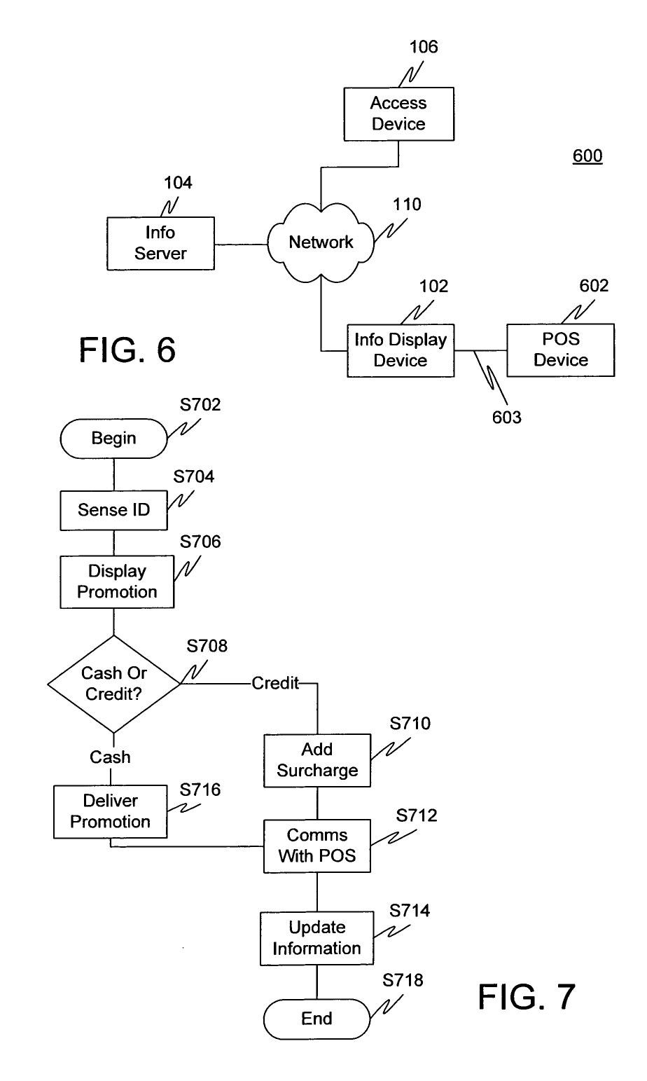

FIG. 6 illustrates a further exemplary embodiment of the present invention. The exemplary system of the embodiment illustrated in FIG. 6 includes information server 104, network 110, access device 106, and information display device 102 shown FIG. 1 and discussed above. For the sake of clarity FIG. 6 does not show the identification-carrying device 108. Further, for the sake of brevity and clarity, the similar features shared by both embodiments illustrated in FIGS. 1 and 6 are shown with same numerical labels, and their descriptions are not repeated hereafter.

FIG. 6, in addition to including all the features of FIG. 1, also includes point-of-sale (POS) device 602 interfacing with the information display device 102. During a transaction in which the total amount of sale is needed to determine a discount or surcharge to be given or added, the information display device 102 can query or monitor the POS device 602 to obtain the sales data.

FIG. 7 illustrates an exemplary process of providing an incentive to customers to make a payment with cash using the system illustrated in FIG. 6. In particularly, the process begins in step S702 and continues to step S704. In step S704, a customer can optionally be prompted to place their identification device in the sensible area of the identification sensor. For example, the prompting can be based on an audio or video cue that could, for example be triggered upon a customer being with a certain proximity to an information display device. Naturally, following the optional sensing of the customer's identification, the customer-specific information is retrieved from the identification-carrying device or from the profile/history storage 138 in the information server 104. Then, the user profile associated with the sensed identification code is optionally reviewed. The process then continues to step S706.

In step S706, a promotion directed to encouraging the customer to pay with cash for the pending transaction is presented. The promotion can be in the form of an audio message, or a graphic presentation, or a combination thereof. This step of presenting the promotion can be omitted if the customer's retrieved history shows a preference for cash payment for all purchases transactions where a discount is offered for cash payment. However, since there is a probability that the customer may not have any cash available, a confirmation of the customer's preference can be preferred.

Once a selection is made by a customer, exemplary courses of action can be taken, as shown in step S708. If cash payment is selected, the process continues to step S716 where a reward is delivered. The reward can be in a number of forms, such as an instant cash discount for the pending transaction, coupon for cash redemption, discount coupon for services, such as car washing, automobile inspection, automobile repair and maintenance, etc., free or discounted merchandises, such as foods, drinks, gas, videos, music, and etc. Coupons or redeemable rewards can be printed using printer 126 associated with the information display device 102 in FIG. 1.

In the case where instant cash discount is based on the total amount of goods or services purchased, the total amount reflected on the point-of-sale terminal is used in computing the discount to be rewarded. In order to obtain the total amount from the point-of-sale terminal, a means for the information display device to receive the total amount can be provided, such as shown in link 603 between information display 102 and POS device 602 in FIG. 5. This link may be a direct wired or wireless link between the two electronic devices, or it may be an indirect link via an operator monitoring the transaction being made. The cash discount can be added to the total purchase by passing the discount information to the POS device 602 directly or indirectly through the intervention of an operator overseeing the purchase transaction, as shown in step S712.

In the case where credit payment is selected by the customer in step S708, a surcharge can be optionally added in step S710, and the surcharge amount is passed to the POS device 602 directly or indirectly through the intervention of an operator overseeing the purchase transaction, as shown in step S712. Although FIG. 7 illustrates both the addition of a surcharge in case of a credit card payment and the delivery of a reward or promotion for cash payment, the process should be understood as also having the flexibility to select either a method for providing an incentive for cash payment or a method for providing a disincentive for credit card payment or other payment types.

If the customer has an identification code and is detected by the information display device, past purchase history and personal profile and preferences, for example, can be used to dynamically determine the amount of discount given, the amount of surcharge to be added, or actions to be taken as an encouragement to pay cash or as a discouragement from paying by credit card.

In addition to taking the aforementioned factors into consideration in determining a reward or surcharge, the time of purchase, the item purchased and manufacturer incentives can also be accounted for in determining a reward or surcharge. Time-related discounts or incentives can be used to motivate and attract customers to frequent the retailer during off-peak hours or during business day where business is customarily not busy.

In step S714, the action taken in step S710 or the step taken in S716 can be reported to information server 104 so that customer's selection and purchase habits or history can be recorded for future reference, if customer's identification was sensed at the beginning of the transaction. Further, the promotion delivered in step S716 can also be recorded for inventory purposes, even if no customer identification was sensed and the transaction is not associated with the customer. For example, if the reward is a coupon for a soft drink, upon redemption information on the coupon can be scanned for verification and inventory can be updated automatically. As another example, if the reward was cash discount, a receipt journal (not shown) can be updated automatically. Finally, the process ends in step S718 where the purchase transaction is completed.

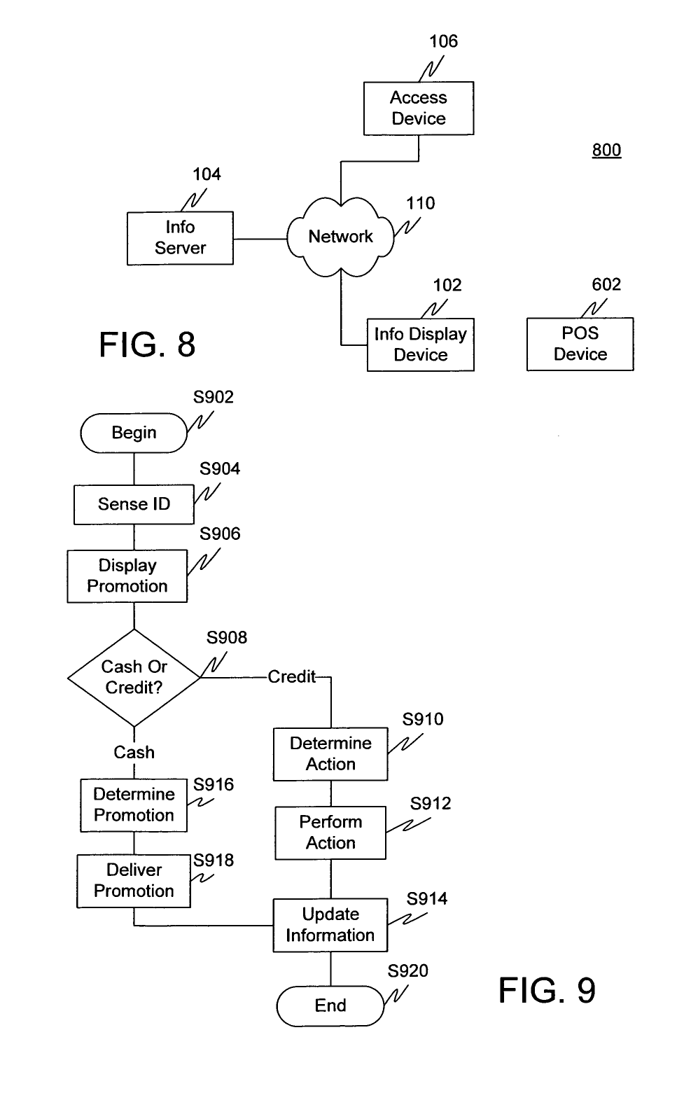

The above-described exemplary system of the present invention notably includes the communication between the POS device 602 and the information display device 102. This communication, via a direct electronic interface or an indirect intervention of an operator, allows the total price to be paid by the customer to display on the POS device 602 which instantly reflects any cash discounted rewarded or any surcharged added. However, in the case where information flow between a POS device 602 and a information display device 102 is not desirable to simplify the integration and installation of the information display device 102 and its associated networking components, there is preferably no direct or indirect interface between POS device 602 and the information display device 102, such as shown in FIG. 8.

FIG. 9 illustrates an exemplary process utilizing the system in FIG. 8 for providing an incentive to customers to make a payment with cash. In particularly, the process begins in step S902 and continues to step S904. In step S904, a customer can optionally be prompted to place their identification device in the sensible area of the identification sensor. For example, the prompting can be based on an audio or video cue that could, for example be triggered upon a customer being with a certain proximity to an information display device. Naturally, following the optional sensing of the customer's identification, the customer-specific information is retrieved from the identification-carrying device or from the profile/history storage 138 in the information server 104. Then, the user profile associated with the sensed identification code is optionally reviewed. The process then continues to step S906.

In step S906, a promotion directed to encouraging the customer to pay with cash for the pending transaction is presented. The promotion may be in the form of an audio message, or a graphic presentation, or a combination thereof. This step of presenting the promotion may be omitted if the customer's retrieved history shows a preference for cash payment for all purchases transactions where a discount is offered for cash payment. However, since there is a probability that the customer may not have any cash available, a confirmation of the customer's preference can be preferred.

Once a selection is made by a customer, exemplary courses of action can be taken, as shown in step S908. If cash payment is selected, the process continues to step S916 where a reward is delivered. The reward can be in a number of forms, such as an instant cash discount for the pending transaction, coupon for cash redemption, discount coupon for services, such as car washing, automobile inspection, automobile repair and maintenance, and free or discounted merchandises, such as foods, drinks, gas, videos, music, and etc. Coupons or redeemable rewards can be printed using printer 126 associated with the information display device 102 in FIG. 1.

In the case where instant cash discount is based on the total amount of goods or services purchased, the total amount reflected on the point-of-sale terminal can be used in computing the discount to be rewarded. However, unlike the process in FIG. 7, the means for the information display device to receive the total amount can be provided but without a link between the information display 102 and the POS device 602, as shown in FIG. 8. This can be done via, for example, an operator monitoring the transaction being made. The cash discount can be added to the total purchase, for example, by passing the discount information to the POS device 602 through the intervention of an operator overseeing the purchase transaction.

If the customer has an identification code and is detected by the information display device 102, past purchase history and personal profile and preferences, for example, can be used to dynamically determine the amount or type of discount or reward given.

In addition to taking the aforementioned factors into consideration in determining a reward for cash payment, the time of purchase, the item purchased, weather condition, manufacturer incentives, and the like, can also be accounted for in determining a reward. Time-related discounts or incentives can be used to motivate and attract customers to frequent the retailer during off-peak hours or during business day where business is customarily not busy. Current weather condition can be used to target weather-related services or merchandises.

As previously mentioned, although the POS device's sales information can be utilized, an electronic link between information display device 102 and POS device 602 is preferably omitted for an increase in simplicity in the installation of the system and for a decrease in hardware cost and maintenance. Hence, actions to be taken in response to customers' selection of cash or credit payment are tailored such that incentive for cash payment or disincentive for credit card payment can still be provided by the information display device 102 without entailing a connection to the POS device 602.

In the case where credit payment is selected by the customer in step S908, instead of adding a surcharge, as in step S710 of FIG. 7, an appropriate action is determined in step S910. Based on user profile and purchase history, if the identity of the customer was sensed, or based on other factors such as time, date, item being purchased, the weather condition, etc., a suitable action can be dynamically determined. For example, a message can be played by the information display device for the customer to further encourage the alternative cash payment in future transactions.

In step S914, the action taken in step S910 or the step taken in S916 can be reported to information server 104 so that customer's selection and purchase habits or history can be recorded for future reference, if customer's identification was sensed at the beginning of the transaction. Further, the promotion delivered in step S916 can also be recorded for inventory purposes, even if no customer identification was sensed and the transaction is not associated with the customer. For example, if the reward was cash discount, a receipt journal, not shown, can be updated automatically. Finally, the process ends in step S920 where the purchase transaction is completed.

Thus, the exemplary embodiments include employing a multimedia information display to offer customers an incentive to make a purchase with cash payment and to dispense a reward for paying with cash, determining how payment is made for a purchase transaction and rewarding customers, based on the type of payment made based on at least one of loyalty program, user history, current transaction data, past transactions, and user profile, providing a cash discount through the use of an information display device if customers make a cash payment in lieu of a credit card payment, adding a surcharge to the total amount due if a purchase is paid with a credit card, communicating with a point-of-sale terminal to add a surcharge to the total sale of a transaction if cash payment is not selected, communicating with a point-of-sale terminal to discount the total sale of a transaction, and the like.

U.S. patent application Ser. No. 10/396,499, incorporated by reference herein, describes exemplary systems and methods that can be used, for example, as part of a loyalty system, or in general any suitable system where there is an attempt to encourage potential participants to join. For example, an exemplary result of the exemplary systems and methods are to reduce the effective costs associated with customer acquisition and to automate the customer acquisition process to, for example, expand the loyalty base.

The exemplary systems and methods are designed to operate as part of a loyalty system that is able to sense the presence of a customer and to deliver content based on whether that customer is identified as a member of the system. For example, in accordance with an exemplary embodiment, a customer identified as a member requires no additional acquisition. However, if the customer is identified as not being a member, the systems and methods of this invention perform a specific task based on this identification. For example, for these non-member customers, the exemplary systems and methods of this invention attempt to entice the customer to become a member of the loyalty system through, for example, either an audio, video, multimedia, and the like, message.

Non-member customers can be identified as such by, for example, the customer's failure to identify themselves as a member customer within, for example, a specific amount of time. If subsequent to being identified as a non-member customer, the customer does identify themselves to the system as a member customer, the acquisition system could, for example, halt presentation of the current content, and switch to a mode of operation appropriate for a member of customers.

Accordingly, the exemplary systems and methods facilitate customer acquisition, relate to facilitating customer acquisition in a loyalty system, relate to determining and delivering content based on a customer's identification, and relate to configuring a customer acquisition system for use in a particular environment.

The following exemplary systems and the methods will be described in relation to customer acquisition systems in general. The exemplary embodiments can be scaled to any suitable level and are capable of working in conjunction with various types of loyalty systems, customers, and already existing systems. While the exemplary embodiments illustrated herein show the various components of the customer acquisition system collocated, it is to be appreciated that the various components of the system can be located at distant portions of a distributed network, such as a WAN and/or the Internet, or within a dedicated customer acquisition system. Thus, it should be appreciated that the components of the customer acquisition system can be combined into one or more devices or collocated on a particular node of a distributed network, such as a communications network. It will be appreciated from the following description, and for reasons of computational efficiency, that the components of the customer acquisition system can be arranged at any suitable location within a distributed network without affecting the operation of the system.

Additionally, it should be appreciated that the various links connecting the elements can be wired or wireless links, or any suitable combination thereof, or any other suitable known or later developed element(s) that is capable of supplying and/or communicating data to and from the connected elements. Additionally, the term module as used herein can refer to any suitable known or later developed hardware, software, or combination of hardware and software that is capable of performing the functionality associated with that element. Likewise, for example, to facilitate scaling of the system, one or more components of the customer acquisition system can be mirrored at one or more locations. Similarly, each of the components illustrated, for example, in a loyalty module can be distributed, replicated, and/or mirrored at one or more loyalty modules and loyalty servers within a loyalty system.

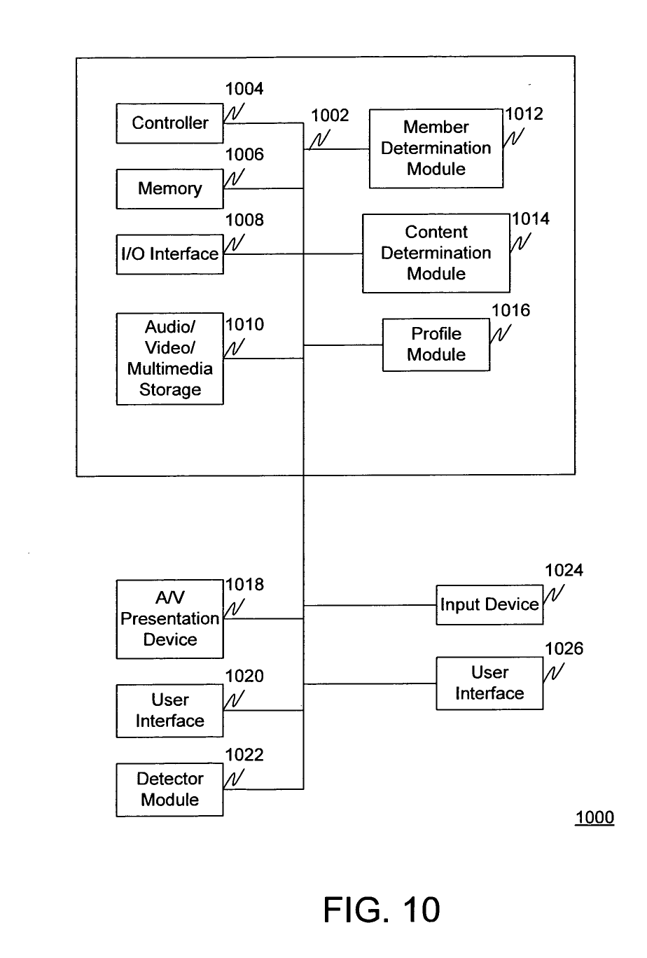

FIG. 10 illustrates an exemplary customer acquisition system 1000. The customer acquisition system 1000 can include a controller 1004, a memory 1006, an I/O interface 1008, an audio/video/multimedia storage device 1010, a member determination module 1012, a content determination module 1014 and a profile module 1016, connected via link 1002. The customer acquisition system 1000 also can include an A/V presentation device 1018, a user interface 1020, a detector module 1022, an input device 1024 and user interface 1026, again connected via link 1002.

In operation, a user, via the input device 1024 and the user interface 1026, interfaces with the content determination module 1014, and the audio/video/multimedia storage 1010. In particular, a user, such as a customer acquisition manager, initializes the system by identifying one or more portions of content that will be associated with an activity, or lack thereof, at the customer acquisition system 1000. For example, the user can specify specific content to be displayed to a customer, specific content for a member, or, for example, generic content to be continuously disseminated. Upon establishing the various type of content the customer acquisition system 1000 will distribute to various customers, as discussed herein below, the system can be placed in operation.

Specifically, the detector module 122 can detect the presence of a customer. For example, the detector module 122 can be a proximity detector, such as an electrical, electro-mechanical, magnetic, inductive, capacitive, and/or optical detector, a credit card reader, a switch, an RFID device, or in general any suitable device that is capable of indicating to the customer acquisition system 1000 that a customer is present. For example, the presence of a user can be triggered by the user activating a gas pump, and the like. Upon detecting the presence of a customer, the customer acquisition system 1000, in cooperation with the controller 1004, memory 1006, I/O interface 1008, and member determination module 1012, attempts to determine if the customer is a member of the loyalty system. For example, member determination module 1012 can look at any suitable information acquired from the customer, such as credit card information, swipe tag information, PIN information, license plate detection information, fingerprint information, or an indication from the customer, for example, via the user interface 1020, to determine whether the customer is a member. Based on this determination, and in cooperation with the content determination module 1014, the customer acquisition system 1000 determines what type of content, if any, should be presented to the customer.

If content is to be presented, the content determination module 1014 cooperates with the audio/video/multimedia storage 1010 along with the controller 1004, memory 1006, and I/O interface 1008 to deliver the content via the A/V presentation device 1018 to the customer. Alternatively, the content determination module 1014 can be connected to, for example, one or more streams of content (not shown), e.g., news, radio, and the like, that could also be displayed on the presentation device 1018 in real or near real time. Furthermore, the content determination module 1014 can work in cooperation with the profile module 1016 to further assist in identifying specific content to be provided to a customer. For example, the profile module 1016 can store information such as customer loyalty, preference, order placement, and history data that may be associated with a customer. For example, the profile module 1016 can cooperate with the content determination module 1014 to determine the type of content, if any, to present to a customer based on the current transaction, the history of transactions associated with the particular customer, a reward system, a promotion, and the like. For example, the systems and methods of this invention can work in conjunction with U.S. patent application Ser. No. 10/137,375, incorporated by reference herein.

Upon the content determination module 1014 determining the type of content to be presented to a customer, with the cooperation the audio/video/multimedia storage 1010, I/O interface 1008, memory 1006, controller 1004, and A/V presentation device 1018, the content determination module 1014 presents the content to the customer.

As discussed previously, the customer acquisition can be scaleable as well as dynamic. For example, one or more of the user interface 1020 and detector module 1022 can monitor customer activities at the customer acquisition system 1000. For example, if the customer purchases a predetermined amount of a particular product, appears to be interested in more information on a particular portion of content, for example by pressing a “Request More Information” button (not shown) on the user interface 1020, and the like, the content determination module 1014 can interject and, for example, in cooperation with member determination module 1012 and profile module 1016 determine supplemental content, if any, to be presented to the customer. In one exemplary embodiment, generic content could be streaming to the A/V presentation device 1018. Upon the detector module 1022 detecting the presence of a customer within a specific area of the A/V presentation device 1018, the customer acquisition systems 1000 streams a first type of content. During the presentation of the content, the controller 1004 can maintain information about the playback location in the content including specific information about, for example, one or more promotions. Then, if the detector module 1022 detects that the customer has triggered, for example by approaching, for example the A/V presentation device to, for example, see or hear more clearly specific content, the customer acquisition system 1000 can dynamically detect the change in status of the customer and the content determination module 1014 could modify subsequent content, by, for example, forwarding detailed content that corresponds to the information being presented when the customer approached the A/V presentation device 1018.

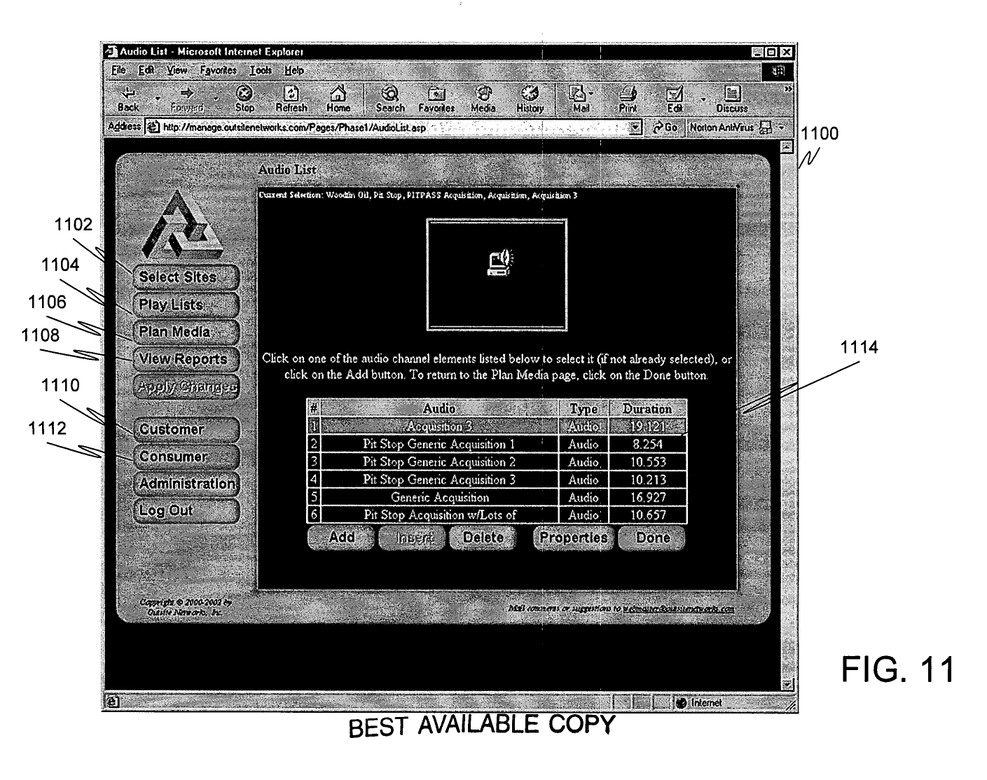

FIG. 11 illustrates an exemplary user interface 1100 that could be displayed on the user interface 1026. Then, via the input device 1024, such as a mouse and the like, the user selects and/or configures the various types of content that are to be presented based on events at the customer acquisition system 1000. Specifically, selectable portion 1102 allows the user to select a site, or a group of sites, such as a gas station(s), kiosk(s), grocery store(s), department store(s), convenience store(s), any suitable point of sale, and the like, to configure the type of content to be displayed to a customer at that site(s). Additionally, group manipulation of multiple associated sites is also possible through this interface with selections being applied to multiple or grouped sites. Specifically, via the selectable portion 1104, a user selects the play list and in cooperation with selectable portion 1106 determines the sequence of content that should be played at the selected site. Then, as illustrated in portion 1114, the available audio/video/multimedia content portions can be selected and associated with the specific event at the customer acquisition system 1000. User interface 1100 can further include selectable portions 1110 and 1112 that are administrative buttons that allow the selection or modification of properties of customers, e.g., retailers, customer acquisition customers, and the like, and consumers, e.g., tag holders, and the like. For example, through the selectable portion 1110 high level parameters for the system, such as point allotments, personal information, and the like, can be manipulated. Likewise, comparable customer properties can be manipulated through the selectable portion 1112. Furthermore, the user interface 1100 can allow access to reports via the selectable portion 1108 that can, for example, provide specifics, such as what content was presented, when the content was presented, whether the presentment of the content resulted in the customer selecting to become a member of the customer acquisition system, or any other suitable information as appropriate.

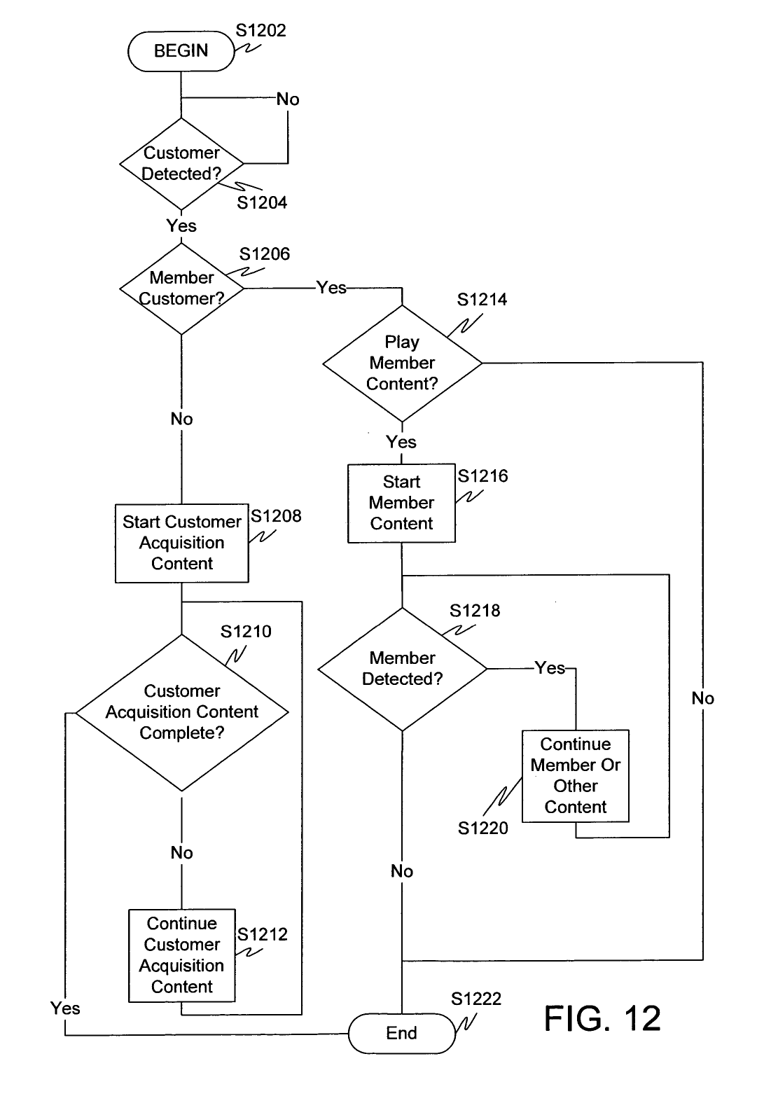

FIG. 12 illustrates an exemplary flowchart of the customer acquisition system in accordance with this invention. In particular, control begins in step S1202 and continues to step S1204. In step S1204, a determination is made whether a customer has been detected. If a customer has not been detected, control jumps back to step 1204. Otherwise, control continues to step S1206. In step S1206, a determination is made whether the customer is a member. If the customer is a member, control continues to step S1214. Otherwise, control jumps to step S1208.

In step S1214, a determination is made whether content for members should be played. If the content is to be played, control continues to step S1216. Otherwise, control jumps to step S1222 where the control sequence ends.

In step S1216, the presentation of member content commences. Next, in step S1218 a determination is made whether the member is still present. If the member is still present, control continues to step S1220. Otherwise, control jumps to step S1222 where the control sequence ends. In step S1220, content continues to be presented to the member. Control then jumps back to step S1218.

In step S1208, customer acquisition content begins playing. Next, in step S1210, a determination is made whether the customer acquisition content is complete. Alternatively, a determination can be made whether the customer has opted to become a member. If the customer has opted to become a member, specific content may be played before the control sequence ends. If in step S1210 the customer acquisition content is complete, control jumps to step S1222. Otherwise, control continues to step S1212 where the customer acquisition content continues. Control then jumps back to step S1210.

While the flowchart illustrated in FIG. 12 shows a very basic exemplary operation of a customer acquisition system, it is to be appreciated that various dynamic features can be interjected in this operational flow to allow increased functionality and, for example, more sophisticated methods of determining content to be presented. For example, as previously discussed, various actions by the customer can be monitored to dynamically adjust content. Alternatively, the system can adapt to customer requests, for example, where a customer does not want to hear content such as member acquisition messages.

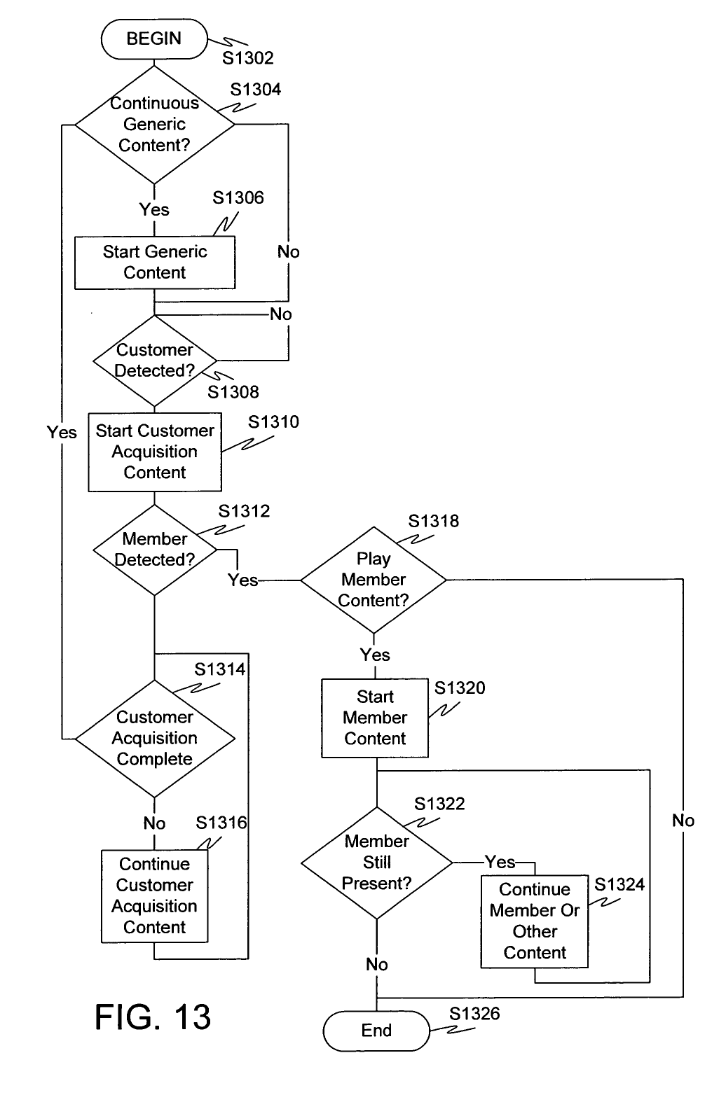

FIG. 13 illustrates an exemplary method for providing content according to this invention. For example, in this exemplary method, the content is continuously presented to acquire new customers. Specifically, control begins in step S1302 and continues to step S1304. In step S1304, a determination is made whether continuous generic content is to be presented. If continuous generic content is to be presented, control continues to step S1306. Otherwise, control jumps to step S1308. In step S1306, the generic content is played. Control then continues to step S1308.

In step S1308, a determination is made whether a customer has been detected. If a customer has been detected, control continues to step S1310. Otherwise, control jumps back to step S1308.

In step S1310, playing of the customer acquisition content commences. This can include asking the customer for an identification. In step S1312, a determination is made whether the customer is a member. If the customer is a member, control jumps to step S1318. Otherwise, control continues to step S1314. Next, in step S1314, a determination is made whether the customer acquisition is complete. If the customer acquisition is complete, control jumps back to step S1304. Otherwise, control jumps to step S1316. In step S1316, the customer acquisition content continues playing. Control then continues back to step S1314.

In step S1318, a determination is made whether content specific to the member is to be played. If contents specific to the member is not to be played, control jumps to step S1326 where the control sequence ends. Otherwise, control continues to step S1320 where playing of the member content commences. Next, in step S1322 a determination is made whether the member's presence continues to be detected. If the member is present, control continues to step S1324 where member or other content is played. Otherwise, control jumps to step S1326 where the control sequence ends.

In addition to the audio/video/multimedia content discussed above, the customer acquisition system can also present a customer with different types of content. For example, some specific member loyalty systems may require the user to fill out a form to enjoy the benefits associated with that program. In this instance, for example, an electronic form could be presented to the user interface 1020 which the customer could fill it out on the spot via, for example, a touch sensitive screen. Alternatively, a printing system, or means for acquiring the customers address could be obtained such that the customer acquisition system 1000 could print out a membership form, or secure the customer address information and forward the appropriate membership materials at a later time.

Furthermore, as discussed previously, the customer acquisition system can be dynamic such that, for example, if the customer indicates via the user interface 1020 that they want to become a member, the system could automatically prompt the customer for an identification, such as a credit card number, an ID number, a drivers license, name, ID tag, and the like, that can be associated with a profile identifying that particular customer as a member.

Additionally, the customer acquisition system need not be limited to one specific “product” line. For example, the customer acquisition system can bridge multiple product and/or service lines and use one or more pieces of information therein to aid in determining content, membership privileges, and the like.

Still further, the customer acquisition system can cooperate with the profile module 1016 such that once a customer has been identified as a member, information in the profile module 1016 further governs how the content determination module 1014 determines the type of content, if any, to be presented to a customer. For example, the profile may be editable by a customer such that the customer can specify they only want to see a particular type of advertisement, or particular type of product promotion. Likewise, the member could specify in their profile that they do not want to receive any content upon identifying to the customer acquisition system that they are a member. Notwithstanding the above, the customer acquisition system may still be able to monitor the activities of the customer and maintain, for example, a historical log of their transactions with the customer acquisition system.

U.S. patent application Ser. No. 10/863,284 describes a stand-alone loyalty system and method that can readily function with existing point-of-sale systems without incurring high cost in retrofitting the existing systems. The exemplary embodiments provide a system, method, and computer program product for a loyalty system based on receipt sniffing, wherein the exemplary systems and methods can be adapted to work in conjunction with existing loyalty systems, or as the basis of a new loyalty system. Specifically, the exemplary systems and methods provide a loyalty module that is retrofitted between a point-of-sale, cash register, or similar device, and the associated receipt printer. This allows the loyalty device to intercept information destined for printing at the receipt printer. With the receipt data, the loyalty module is able to determine which items have been purchased, the price of the item(s), purchaser information, payment type, and the like. Using this information, for example, loyalty points or rewards can be issued based on various parameters.

The exemplary embodiments include a method and system for providing an incentive for a purchase, including monitoring communications between a purchase system and price displaying device to determine information regarding a transaction; identifying at least one item being purchased as part of the transaction from the transaction information; determining a loyalty reward based on the identified item being purchased; and dispensing the loyalty reward.

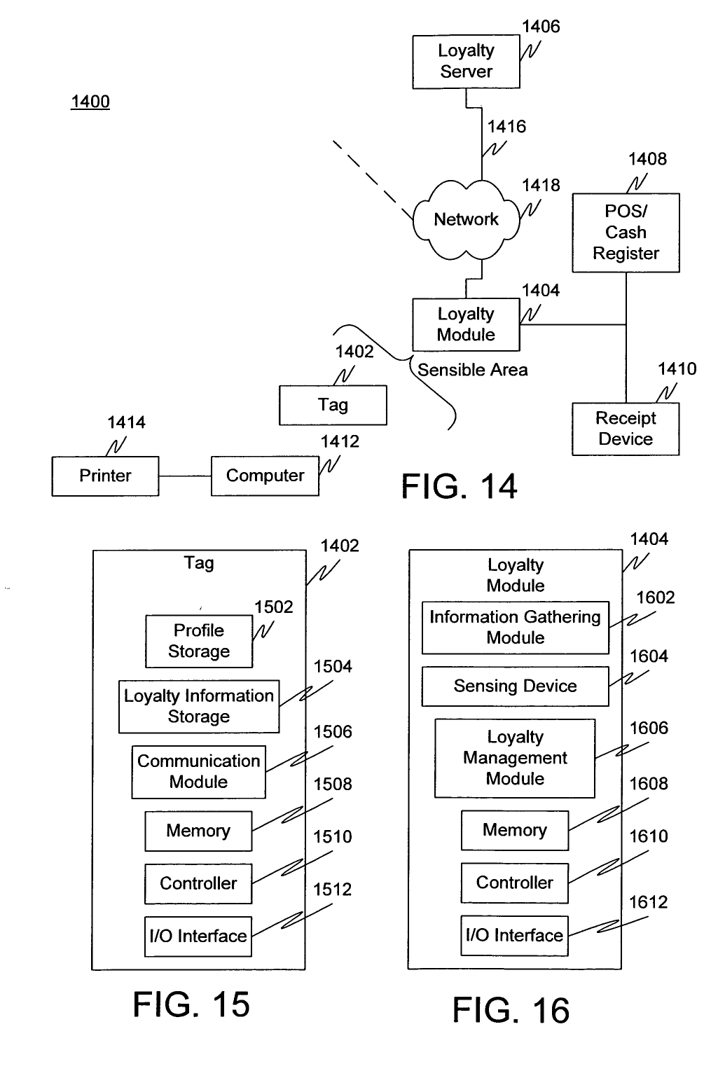

FIG. 14 illustrates an exemplary loyalty system 1400. The loyalty system 1400 can include a tag 1402, a loyalty module 1404, a loyalty server 1406, a point-of-sale device 1408, such as a cash register, and a receipt device 1010, all interconnected by links 1416 and optionally network 1418. Furthermore, the loyalty system 1400 can optionally include a computer 1412 and printer 1414.

In operation, the loyalty module 1404 is adapted to monitor communications between the point-of-sale 1408 and the receipt device 1410. In particular, the loyalty module 1404 can act in an active or passive fashion depending on, for example, rules specified in a profile associated with the tag 1402 as discussed hereinafter. For example, in the passive mode, the loyalty module 1404 can “listen” to communications between the point-of-sale 1408 and the receipt device 1410. Thus, the loyalty module 1404 would at least have the information regarding the transaction that was passed to the receipt device 1410. Based on this information, and a subsequent interaction with one or more of the tag 1402 and the loyalty server 1406, the loyalty module 1404 could allow the issuance of loyalty rewards based on this information.

Alternatively, in an active mode, the loyalty module 1404 could intercept communications between the point-of-sale 1408 and the receipt device 1410. Then, based on an interaction with the tag 1402, the loyalty module 1404 could print one or more of a receipt, a loyalty reward, and the like at, for example, the receipt device 1410.

Having the loyalty module 1404 communicating with one or more of the point-of-sale 1408 and the receipt device 1410, the loyalty module 1404 waits for a tag 1402 to be placed in the sensible area of the loyalty module 1404. For example, the loyalty module 1404 can be equipped with an electrical, electro-mechanical, magnetic, inductive, capacitive, and/or optical detector, a credit card reader, a radio frequency identification (RFID) device, or in general any suitable device that is capable of communicating and exchanging information with a comparably equipped readable/writable technology in the tag. This information can include, for example, profile information and loyalty information that is stored on the tag.

Thus, when the tag 1402 is place in the sensible area of the loyalty module 1404, the loyalty module can determine, based on the information in the tag in combination with current transaction information, if a loyalty reward is appropriate. If a loyalty reward is appropriate, the loyalty module 1404 can cooperate with the tag 1402 and update the loyalty information stored therein. Thus, it is not always necessary for the loyalty module 1404 to communicate with the loyalty server 1406 to be able to determine current loyalty rewards. While this communication is not precluded and, for example, based on information stored in a profile on the tag 1402, this could be an alternative form of operation, it is not necessary.

For example, a profile stored on the tag 1402 could specify that if the tag 1402 is placed in the sensible area of the loyalty module 1404, and a loyalty reward is appropriate, the profile could specify that information relating to the loyalty reward be forwarded to the loyalty server 1406 and then, for example, e-mailed to an address specified in the profile. A user could then receive this loyalty information and, for example, print it out at their convenience. This would allow, for example, the loyalty module 1404 to process loyalty rewards in a batch-processing type of environment, and thus could help eliminate communication bottlenecks that may occur over the network 1418 and at the loyalty server 1406. Alternatively, a tag reader/writer interface (not shown) could be connected to the computer 1412 such that a user, upon receipt of the e-mail indicating a reward has been earned, could place the tag 1402 in the sensible area of the tag reader/writer to update the tag with the reward information. This reward information could then be used, for example, for subsequent purchases at a point-of-sale 1408.

Additionally, the profile may, for example, specify that transaction information should not be printed at the receipt device 1410 at the time the transaction occurs, but rather stored in the tag and, for example, printed at a later time when the tag is placed in communication with the computer 1412 and accompanying printer 1414.

FIG. 15 illustrates in greater detail the components associated with the tag 1402. In particular, the tag 1402 includes a profile storage device 1502, a loyalty information storage device 1504, a communication module 1506, a memory 1508, a controller 1510, and an I/O interface 1512. As will be appreciated, the tag 1402 can further include a power source, such as a battery, rechargeable battery, solar panel, and the like, which are not shown but could also be included in the tag 1402.

In operation, and upon being place in service, the tag 1402 is initialized by, for example, establishing a profile in the profile storage device 1402. A “basic” or stock profile could be included in the profile storage device 1402 and upon receipt, through a user interface, such as a graphical user interface on a personal computer, PDA, and the like, a user would be able to customize the settings in the profile. Alternatively, the tag 1402 can be shipped or given to a user with no profile thus allowing the user to completely configure and customize the profile based on their particular desires. As briefly discussed above, the profile could at least control how information associated with a current transaction is handled. For example, the following exemplary rules can be established that tailor the handling of information based on various factors.

Exemplary Profile A

1. Do not print receipts at receipt device

2. Store transaction information on tag

3. Send e-mail notification if reward earned

4. Use reward to pay or partially pay for transaction if reward available

Exemplary Profile B

1. Print receipts at receipt device

2. Store transaction information on tag

3. Print coupon at receipt device if reward earned

4. Automatically transfer transaction information to financial management software when tag associated with computer

Exemplary Profile C

1. Do not print receipts at receipt device

2. Do not store transaction information on tag

3. Print coupon at receipt device if reward earned

4. Use credit card information associated with tag to pay for transaction

Exemplary Profile D

If at any gas station:

1. Do not print receipts at receipt device

2. Store transaction information on tag

3. Print coupon at receipt device if reward earned

4. Use credit card information associated with tag to pay for transaction

Exemplary Profile E

If at store X:

1. Do not print receipts at receipt device

2. Store transaction information on tag

3. Print coupon at receipt device if reward earned

4. Use credit card information associated with tag to pay for transaction

5. Automatically transfer transaction information to financial management software when tag associated with computer

Associated with a profile is also an identifier that identifies a user associated with the tag 1402. This identification can be shared with the loyalty server 1406 such that when, for example, a profile specifies the handling of transaction information that includes the interaction of the loyalty server 1406, the loyalty server 1406 knows how to process the information based on the identification.

Loyalty information is stored in the loyalty information storage module 1504. Specifically, when the tag 1402 is placed in the sensible area of the loyalty module 1404, and in cooperation with the communication module 1506, the memory 1508, the controller 1510, and the I/O interface 1512, the loyalty information storage device 1504 is able to obtain information about a particular transaction that occurred at the point-of-sale 1408. Then, based on information in the profile, the information regarding the transaction is processed in accordance with those rules. For example, the profile may specify that the transaction information is not to be printed on the receipt device 1410, but rather stored in the loyalty information storage device 1504. For example, this information can include the time and date of the transaction, the store, the items purchased, the amount paid and/or any other suitable information that could be available about the particular transaction. Furthermore, the stored transaction information can be maintained in the loyalty information storage device 1504 to facilitate the returning of items to a store by, for example, placing the tag 1402 in the sensible area of the loyalty module 1404 and specifying that a particular receipt(s) is to be printed. For example, to facilitate this type of activity, a user interface can be provided at a store that would allow the user to access information within the tag 1402.

In addition to being capable of storing information regarding the current transaction, the loyalty module 1404 is able to obtain historical transition information from the loyalty information storage device 1504 to aid in facilitating whether a loyalty reward is appropriate. For example, the loyalty information storage device 1504 may have various portions. One portion may store transaction information, another portion may store reward points, another portion frequent flyer miles, another portion user information, such as credit card number(s), and the like. By separating the various portions, a consumer's information and consumer's privacy can be protected. For example, there may be another rule in the profile storage 1502 that specifies, for example, when the tag 1402 is in communication with the loyalty module 1404, only historical information relating to the particular store or, chain of stores, the user is currently at will be shared with the loyalty module 1404.

Having determined whether any suitable loyalty reward is appropriate, the loyalty module 1404 can return to the tag 1402, via the communication module 1506, the memory 140, the controller 1510, and the I/O interface 1512, any updated loyalty reward information as appropriate. This loyalty reward information can then be stored in the loyalty information storage device 1504. Again, and for example as specified by the profile, a user can establish rules defining how the user is to be kept informed about loyalty information and how loyalty rewards will be process. For example, a new user could specify that when a loyalty reward is available, a light or audible sound (not shown) could be activated on one or more of the tag 1402 and the loyalty module 1404. This would notify the user that a reward is available and then allow, for example, the user to reintroduce the tag 1402 into the sensible area of the loyalty module 1404 and through this pattern of behavior direct the loyalty module 1404 to print the loyalty reward at the receipt device 1410. Alternatively, for example, a user may take the tag 1402 to a location, such as a personal computer in the home, and “synchronize” the tag with the computer 1412. This synchronization could be via a wired or wireless connection, such as a USB or optical connection. A user could then be presented with a user interface that would allow the user to interact with information in the tag 1402 and, for example, specify various portions of information to be printed, such as earned loyalty rewards, transaction information, and the like. Furthermore, the user interface could allow the user to export transaction information stored on the tag into, for example, a banking program in order to facilitate, for example, maintaining for the consumers checking account.

The awarding of loyalty rewards can be governed by at least two mechanisms. First, triggering events, such as frequent flyer miles, dollars spent on purchases, and the like, can be stored in the loyalty information storage device 1504. Thus, when the tag 1402 is introduced into the sensible area of the loyalty module 1404, the loyalty module 1404 has all the necessary information to determine whether a loyalty reward is appropriate. Alternatively, the loyalty module 1404 can communicate with a loyalty server 1406, this loyalty server 1406 could act as a central host system that would allow the uploading and gathering of data, such as consumer activity, number of transactions, transaction breakdown, loyalty points, were awards earned or redeemed, cash register activity, non-loyalty transaction information, and the like. The loyalty server 1406 could also download new loyalty parameters, e.g., triggers, such as new or changed reward levels, specials, and the like, to the loyalty module 1404. Therefore, for example, since the loyalty information and trigger are stored either on the tag 1402 or the loyalty module 1404, real-time communication with the loyalty server 1406 is not mandatory. Furthermore, by using the loyalty server 1406, the store-centric limitations of previous systems are overcome. Additionally, the loyalty server 1406 could at predetermined intervals forward updated “trigger” information to the loyalty module such that when the tag 1402 is next placed in the sensible area of the loyalty module 1404 the triggers on the tag could be updated. An indication of a successful update could then be forwarded back to the loyalty server 1406 to, for example, aid with the monitoring of the status of the tags in service.

Furthermore, it should be appreciated that that the tag, itself, could include programming, or a program configuration which limits the necessity for communicating with the loyalty server 1406. This information could be above and beyond that which is discussed above in relation to triggering. For instance, rules regarding reward scheduling, e.g., when a reward is active, or rules governing combinations of items purchased (or not) in association with rewards or point issuance. n short, as technology improves, aside from periodically updating information in the loyalty module, the tag could also become the repository for additional functional rules and data. A more complex version of the tag could include additional memory and processing logic which would not pass-through the communications to the printer, but would store the communications until a signal, for example, activated by a button, is received instruction all or a portion of the communications to be sent to the printer. Alternatively still, the dongle and printer could be replaced with a dedicated printer, or the printer optionally incorporated in to the tag, for example if the tag is adapted to work with or integrated within PDA.

Likewise, the above configuration at least allows the tag 1402 to be used at a variety of locations, such as grocery stores, gas stations, retail stores, airlines, and the like, that may use the same loyalty program as well as at locations that are on different or may use multiple loyalty programs.

FIG. 16 illustrates an exemplary detailed view of the loyalty module 1404. The loyalty module 1404 includes an information gathering module 1602, a sensing device 1604, a loyalty management module 1602, a memory 1608, a controller 1610, and an I/O interface 1612. The information gathering module 1602 actively or passively intercepts or obtains, respectively, transaction information associated with a transaction at the point-of-sale 1408. For example, as previously discussed, the type of interaction the loyalty module 1404 may have with the transaction information could be depended on information stored in the profile associated with the tag 1402. For example, the loyalty module 1404 could, as a normal course of operation, intercept the transaction information and store it in the memory 1608 prior to sending it to the receipt device 1410. Then, upon having sensed the tag 1402, process the transaction information accordingly. In this manor, paper could be saved in that unnecessary receipts are not printed and consumer information is protected.

For example, for passive operation, a “dongle” can be inserted such that the cable goes from the point-of-sale into the dongle and add another straight-through cable from the other side of the dongle to the printer. Thus, the original circuit can be maintained. Passive circuitry senses the communication signals and passes them to a third cable which is connected to the loyalty module. Power can optionally be provided from the loyalty module over the third cable, although it should be appreciated that power could be obtained from various printer signals or an external power supply, and the like.

The sensing device 1604, in cooperation with the memory 1608, controller 1610, and I/O interface 1612, communicates with the tag 1402 when the tag 1402 is placed in the sensible area of the loyalty module 1404. For example, as previously discussed, the sensing device 1604 can be based on an electrical, electro-mechanical, optical, inductive, capacitive, or other configuration that allows the communication of information between the tag and the loyalty module 1404.

The loyalty management module 1606 reconciles the transaction information with the loyalty information stored on the tag 1402 and determines if a loyalty reward is appropriate. As previously discussed, the triggers that determine when a loyalty reward is appropriate can be received from one or more of the loyalty server 1406 and the tag 1402.

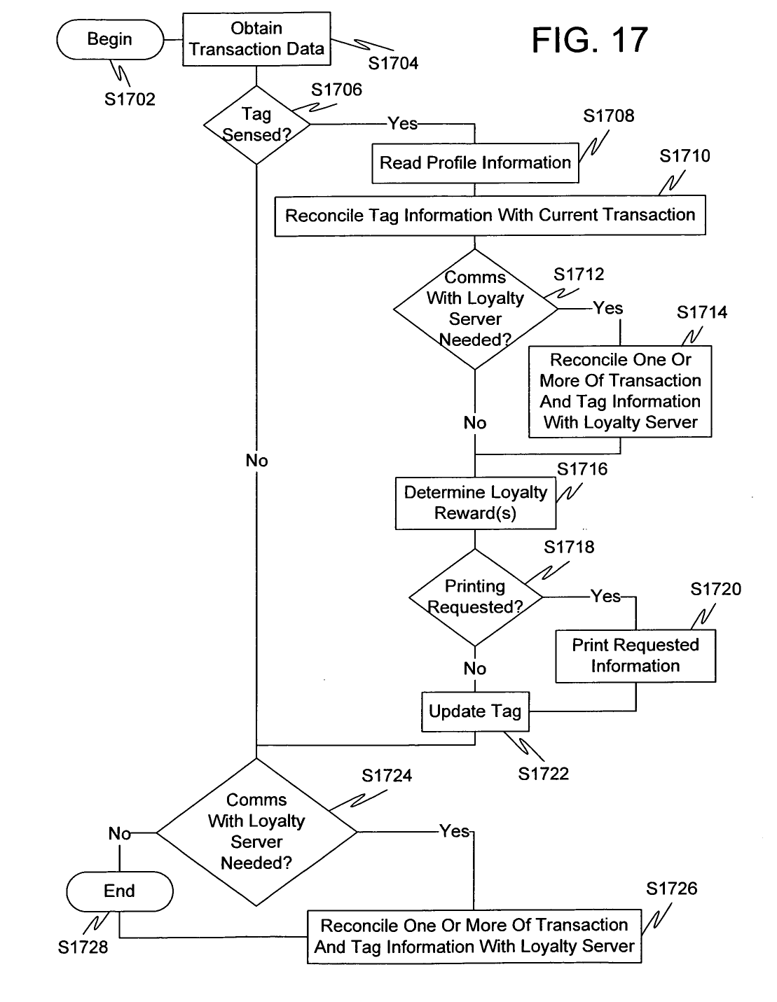

FIG. 17 outlines the exemplary operation of the loyalty system. In particular, control begins at step S1702 and continues to step S1704. In step S1704, transaction data is obtained. Next, in step S1706, a determination is made whether a tag has been placed in the sensible area. If the tag has been sensed, control continues to step S1708. Otherwise, control jumps to step S1724.

In step S1708, profile information is read from the tag. Next, in step S1710, the tag information is reconciled with current transaction information. Then, in step S1712, the loyalty system optionally determines if communications with the loyalty server are needed. If communications are needed, control continues to step S1714 where one or more of transaction and tag information are reconciled with the loyalty server. Otherwise, control jumps to step S1716.

In step S1716, a determination is made whether any suitable loyalty rewards have been earned. Control then continues to step S1718.

In step S1718, a determination is made whether printing is requested. If printing is requested, control continues to step S1720 where the requested information is print. Otherwise, control jumps to step S1722. In step S1722, the tag is updated with any suitable appropriate transaction information and/or loyalty rewards as appropriate. Control then continues to step S1724.

In step S1724, a determination is made whether a communication with the loyalty server is needed. If a communication with the loyalty server is needed, control continues to step S1726. Otherwise, control jumps to step S1728 where the control sequence ends.

In step S1726, one ore more of transaction, tag information and loyalty reward information is reconciled, sent to or received from the loyalty server as appropriate. Control then continues to step S1728 where the control sequence ends.

FIG. 18 outlines the exemplary operation of a tag. In particular, control begins in step S1802 and continues to step S1804. In step S1804, a determination is made whether the tag has been introduced into the sensible area of the loyalty module. If the tag is in the sensible area, control continues to step SI 806. Otherwise, control jumps to step S1810.

In step S1806, and based on the profile, information is forwarded to and/or received from the loyalty module. For example, as previously discussed, instructions for processing transaction data, how to process loyalty rewards, and historical information can be exchanged between the loyalty module and the tag. Then, if necessary, in step S1808, the tag is updated with any suitable appropriate information. Control then continues to step S1810.

In step S1810, a determination is made whether the tag has been connected to an interface device, such as a computer. If the tag is connected to an interface device, control continues to step S1812. Otherwise, control jumps to step S1834 where the control sequence ends.

In step S1812, a determination is made whether a loyalty reward status report is requested. If a loyalty reward status report is requested, control continues to step S1814 where the loyalty reward report is created. Control then continues to step S1816.

In step S1816, a determination is made whether the profile is to be modified. If the profile is to be modified, control jumps to step S1818. Otherwise, control jumps to step S1822.

In step S1818, the profile is modified. Then, in step S1820, the updated profile is stored. Control then continues to step S1822.

In step S1822, a determination is made whether to review and/or modify transaction history information. If a review or modification of the history information is required, control continues to step S1824. Otherwise, control jumps to step S1826.

In step S1824, the user is allowed to modify and/or review history information via, for example, a user interface, as discussed above. Control then continues to step S1826.

In step S1826, a determination is made whether a portion of the history is to be printed. If a portion of the history is to be printed, control continues to step S1828 where the portion is printed. Otherwise, control jumps to step S1830.

In step S1830, a determination is made if a communication with the loyalty server is needed. If communication with the loyalty server is needed, control continues to step S1832. Otherwise, control jumps to step S1834 where the control sequence ends.

In step S1832, the tag, via the interface device, communicates with the loyalty device to, for example, backup changes, provide additional information, store updated profile information, and the like. Control then continues to step S1834 where the control sequence ends.

Thus, according to the exemplary embodiments, a consumer can receive earned points or rewards, if any, by simply associating a tag with the loyalty module. The loyalty module is capable of reading consumer information from the tag, such as current loyalty points status, earned rewards, and a consumer identification. The loyalty module is then able to store updated status reward information on the tag. The loyalty module is also able to issue loyalty rewards in the form of printed data, such as coupons or receipts, by sending data to either the cash register printer or another printer. The exemplary embodiments provide the ability for storing a plurality of types of information on a tag that allows a loyalty system, based on the information, to determine various rewards and/or points. Further, the exemplary embodiments include providing a tag that is capable of storing transaction information, and providing a tag that is modifiable and accessible to manage transaction information and loyalty information stored therein.

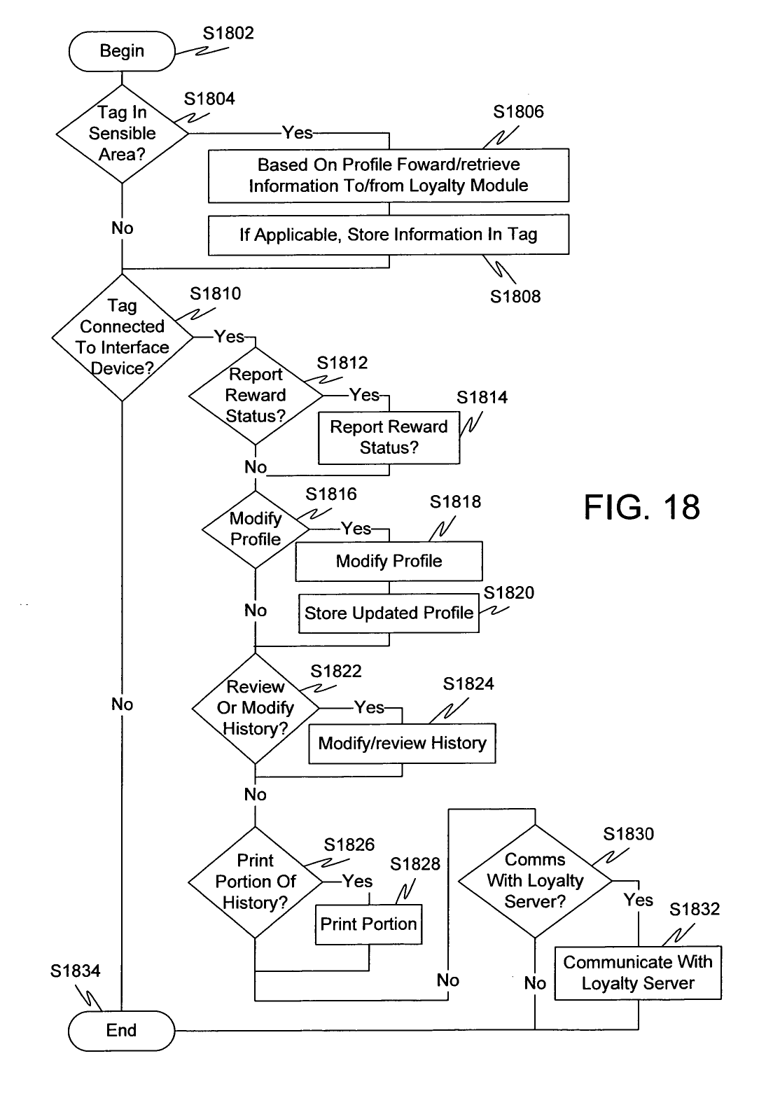

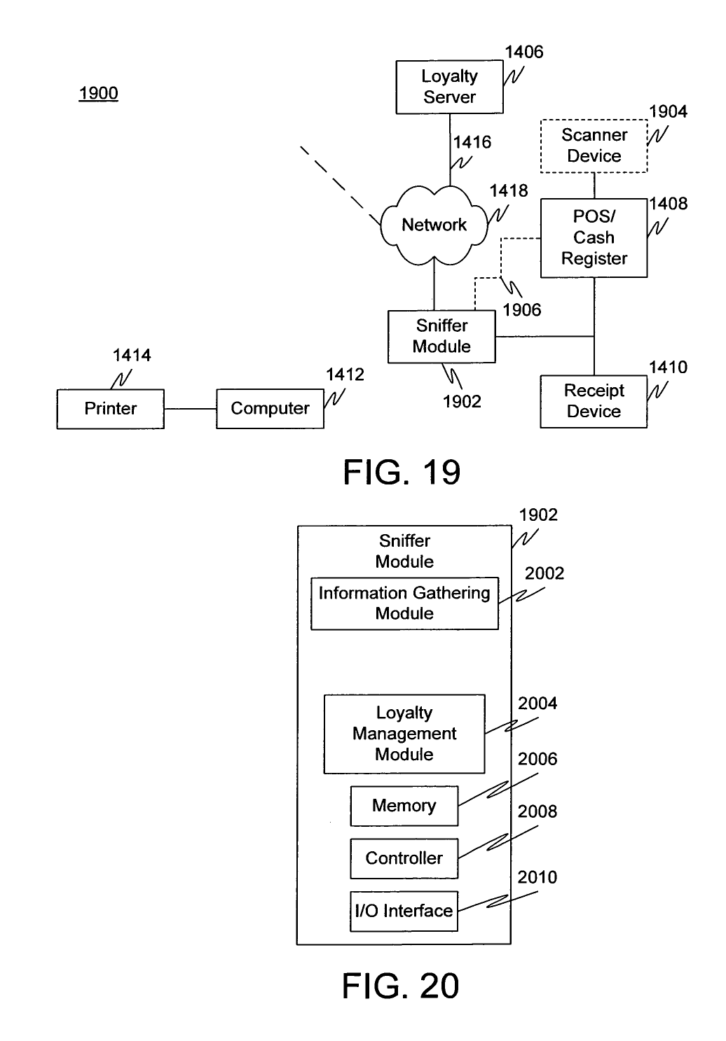

Accordingly, as described, in the system of FIG. 14, loyalty module 1404 works in conjunction with tag 1402, which includes consumer information from the tag, and other associated modules to execute the aforementioned processes. However, to achieve greater flexibility, affordability, and simplicity, the loyalty system 1400 in FIG. 14 may be implemented without the loyalty module 1404 and tag 1402. An exemplary alternative embodiment to loyalty system 1400 in FIG. 14 is shown as loyalty system 1900 in FIG. 19. For the sake of brevity and clarity, the similar features shared by both embodiments illustrated in FIGS. 14 and 19 are shown with same numerical labels, and their descriptions are not repeated hereafter.

In FIG. 19, loyalty system 1900 is shown with sniffer module 1902 and with no ability to sense a tag including consumer information. The sniffer module 1902 operates in similar manner as loyalty module 1404 in FIG. 1 in that the sniffer module 1902 is interposed between, for example, a cash register or point of sale system 1408, and a receipt printer 1410. As such, the sniffer module 1902 is adapted to actively or passively monitor information passed between the cash register or point of sale system 1408 and the receipt printer 1410. The information can be, for example, item information, purchaser information, store information, time and date information, or any other suitable information that could be used by a loyalty system to assist in determining if a loyalty reward has been earned. The receipt printer 1410 can be a traditional receipt printer, or an electronic device that, for example, stores electronic receipt information for the consumer.

FIG. 20 illustrates an exemplary detailed view of the sniffer module 1902. In FIG. 20, the sniffer module 1902 includes an information gathering module 2002, a loyalty management module 2004, a memory 2006, a controller 2008, and an I/O interface 2010. The information gathering module 2002 actively or passively intercepts or obtains, respectively, transaction information between the point-of-sale system 1408 and the receipt printer 1410 and associated with a transaction the point-of-sale system 1408.

In an active mode of operation, the sniffer module 1902, in a normal course of operation, intercepts the transaction information and stores it in the memory 2006 prior to sending it to the receipt device 1410. In a passive operation, a “dongle” can be inserted, such that the cable goes from the point-of-sale system 1408 into the dongle and another straight-through cable is added from the other side of the dongle to the receipt printer 1410. Thus, the original circuit, advantageously, can be maintained with this embodiment. Appropriately configured circuitry senses the communication signals and passes them to a third cable which is connected to the sniffer module 1902. Power can optionally be provided from the sniffer module 1902 over the third cable, although it should be appreciated that power could be obtained from various printer signals or an external power supply, and the like.

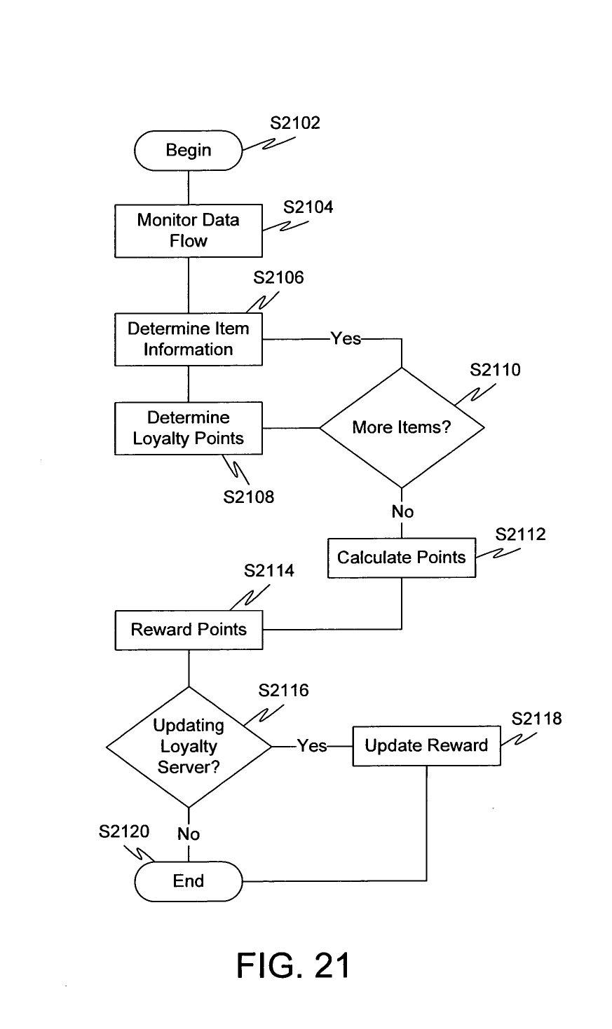

FIG. 21 outlines an exemplary operation of the loyalty system 1900, particularly the sniffer module 1902. In particular, control begins at step S2102 and continues to step S2104. In step S2104, data flow between, for example, a POS device or cash register 1408 and a receipt device 1410, as shown in FIG. 19, are monitored. Next, in step S2106, the monitored data is analyzed for specific information, such as, for example, a time and date of a transaction, a retailer's identification and location, an item being purchased, an item's price and quantity, and the like. The date, time and retailer's location information, advantageously, can be employed to promote “happy hours” to attract business during off-peak days and times.

Based on the analyzed data, loyalty points are dynamically determined in step S2108. If there are more items to be monitored, as determined in step S2110, steps 2106 and 2108 can be repeated until there are no more items to be purchased. For example, when a total is calculated by the POS device, the loyalty point determination can be stopped and the total number of loyal points can be calculated in step S2112. After the total number of loyalty points earned are calculated, at step S2114, the sniffer module 1902 transmits the appropriate information to an associated device for dispensing a reward based on the number of loyalty points earned for immediate consumption or records the loyalty point information on a media to be given to the consumer.

Next, in step S2116, the control determines whether or not to update the loyalty server 1406 with information related to the current transaction. If the loyalty server 1406 is available and reconciliation is desired, the sniffer module 1902 transmits the transaction information to the loyalty server 1406. If reconciliation with the loyalty server 1406 is not possible or desirable, the control ends at step S2120. Reconciling the loyalty server 1406 with transaction data can be used for collecting customers' purchase history, buying habits, and the like, advantageously, which can be used, for example, to determine future marketing of merchandises.

In contrast with the loyalty system 1400 in FIG. 14, the loyalty system 1900 in FIG. 19 is free from the requirement of a consumer tag and the sensing of the tag to determine the information related to the consumer and the loyalty reward to be given. Hence, the cost of implementing and maintaining the loyalty system, including administering the tags, can be greatly reduced, and the capability of the loyalty system can be tailored to the specific need of each retailer. Further, the loyalty system 1900 allows purchase data to be collected and analyzed without requiring customers to register for tags and sharing private information.

Advantageously, the above-described exemplary embodiments increase the flexibility, affordability, and simplicity of the loyalty system, wherein no information tag is necessary for determining loyalty points to be rewarded. The exemplary embodiments provide the ability, for example, to gather purchase information and dispense loyalty reward without requiring customers to have a tag and, hence, increases customers' privacy and reduces the cost of the system by, for example, eliminating the administering of tags to customers and maintaining the tags. Aspects of the invention also related to providing a self contained electronic loyalty system. Accordingly, the exemplary embodiments include a loyalty system that can be retrofitted with a purchase system having a price-displaying device for monitoring communication between the purchase system and the price-displaying device, determining loyalty rewards and dispensing rewards without using a tag including consumer information, a loyalty system including a sniffer module that intercepts data traffic between a point-of-sale terminal and a receipt printing device or a price display device, a loyalty system including a sniffer module that intercepts data traffic between a check-out register and a price scanning device, a loyalty system including a sniffer module that intercepts data traffic between a point-of-sale terminal and a journal printer, and the like.

U.S. patent application Ser. No. 10/648,443, incorporated by reference herein, recognizes that it would be advantageous to provide a loyalty mechanism for a retailer that rewards fuel purchases differently from non-fuel purchases and/or that may combine the fuel reward points with the non-fuel reward point for a single reward system. This basic concept can be expanded to include differentiate types of products or services from other products or services, such that, for example, different loyalty rewards can be based on one or more categories or types of related goods or services.

The exemplary embodiments of U.S. patent application Ser. No. 10/648 relate to loyalty systems, a loyalty tag that can be used a plurality of different locations, a loyalty tag that can be used at a plurality of non-related locations, a loyalty point system, a loyalty point system that issues different rewards based on specific categories of goods or services purchased, a loyalty point system that issues different rewards based on different categories of goods or services purchased, a loyalty reward system, wherein different categories of rewards can be issued for a single purchase, a loyalty system that can provide varied rewards based on whether the purchases are for fuel or non-fuel transactions, and the like.

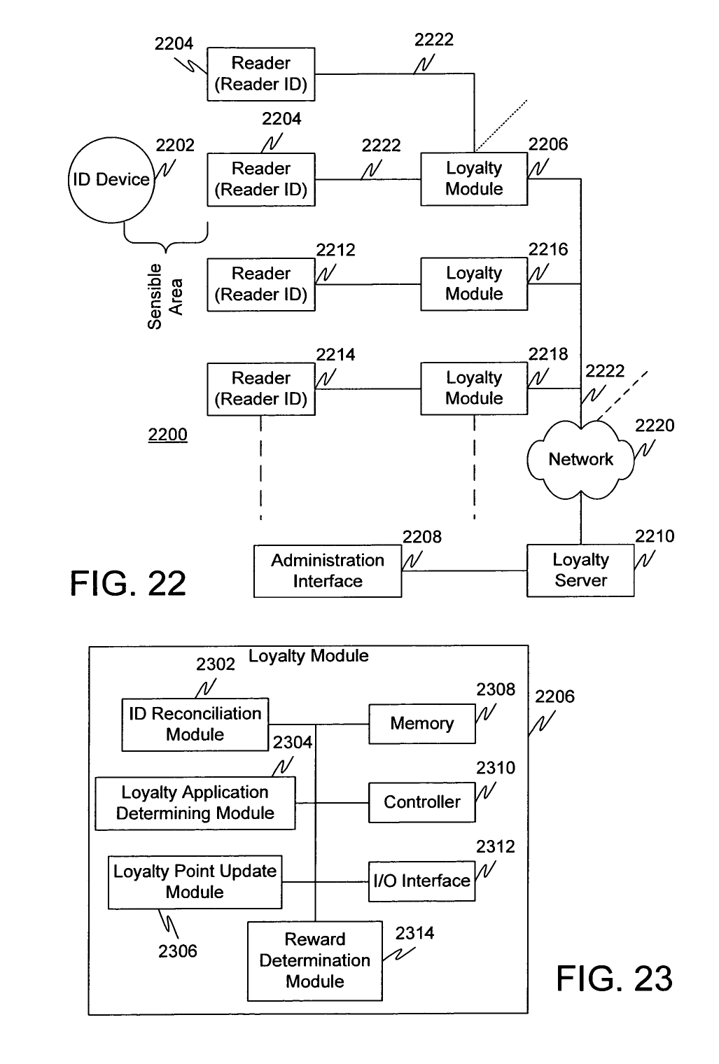

FIG. 22 illustrates an exemplary loyalty system 2200. The loyalty system 2200 includes one or more readers 2204, 2212, and 2214, each having an associated reader ID, with more than one reader being capable of being attached to each of one or more loyalty modules 2206, 2216, and 2218, one or more ID devices 2202, each having a device identifier, a loyalty server 2210, and an administration interface 2208, with the various components being interconnected by one or more links 2222 and network(s) 2220. In general, and in accordance with an exemplary embodiment, each reader has associated reader identification (reader ID) that identifies the reader. Thus, upon, for example, a user introducing the ID device 2202 into the sensible area of a reader, the combination of the device identifier on the ID device 2202 and the reader ID on the reader 2204 are used to determine which loyalty application(s) the ID device 2202 is being used for. For example, using the combination of reader ID and device identifier on the ID device 2202, one or more particular loyalty applications can be selected or, for example, as an alternative, a particular loyalty application excluded.

For example, the ID device and readers can be equipped with electrical, electro-mechanical, magnetic, inductive, capacitive and/or optical communication systems, the reader can be a credit card reader and the ID device a credit card, the reader a radio frequency identification device (RFID) and the ID device an RFID tag, or in general, any suitable device or combination of devices that are capable of communicating and exchanging information, such as identifiers, between the identification device and the reader. In addition to the identifier information, the ID device 100 can also store and/or receive profile information, loyalty information, reward information, and the like.

Thus, in operation, the loyalty server 2210 is configured and populated with, for example, via the administration interface 2208, the various readers, and associated reader IDs, and device identifiers that are in the system. Since each ID device 2202 has a specific device identifier, and each reader has an associated reader ID, for example, through the use of a table, the loyalty system 2200 can determine one or more appropriate loyalty applications based on this combination of IDs.

For example, the various combinations of IDs can be stored in a table or similar database that allows the loyalty system 2200 to determine the appropriate loyalty application based on which reader the ID device 2202 is presented to. Specifically, upon presentment of the ID device 2202 to a reader, such as reader 2204, the reader 2204 communicates, via link 2222, with the loyalty module 2206. The loyalty module 2206 having all or a portion of the reconciliation table stored thereon is then able to determine the appropriate loyalty application(s) for use with this ID device 2202. Alternatively, the loyalty module 2206, upon receiving the combination of the device identifier from the ID device 2202 and the reader ID from the reader 2204, can forward this information, via link 2222 and network 2220, to the loyalty server 2210. Additionally, the ID device can be auto-registered upon presentment to the system and one or more of a loyalty application automatically determined or the user queried for which loyalty program they would like to become a member of. The loyalty server 2210 can then determine the appropriate loyalty application(s) and respond to the loyalty module 2206 with the appropriate instructions for which loyalty application(s) is appropriate and, for example, how to determine loyalty rewards. Upon selection of the appropriate loyalty application, the loyalty module 2206 can update the loyalty rewards, if any, for the user associated with ID device 2202. For example, the loyalty module 2206 in cooperation with the reader 2204, can transfer information to a memory (not shown) located on the ID device 2202 that is capable of storing the rewards information. Alternatively, one or more of the loyalty module 2206 and loyalty server 2210 can maintain a record of the rewards earned in conjunction with the current transaction.

FIG. 23 illustrates in greater detail an exemplary loyalty module 2206. However, it should be appreciated, that while the components within the loyalty module 2206 are shown collocated in the loyalty module, one or more of these components could also be distributed within the loyalty system 2200, such as in the loyalty server 2210. In particular, the loyalty module 2206 includes an ID reconciliation module 2302, a loyalty application determining module 2304, a loyalty point update module 2306, a memory 2308, a controller 2310, an I/O interface 2312, and a reward determination module 2314.

In operation, the loyalty module 2206 receives, from the associated reader and once an ID device is introduced into the sensible area of the reader, the reader ID and the device identifier associated with the ID device 2202.

Typically the ID reconciliation module just forwards the device identifier and the reader ID to the loyalty application determining module 2304. However, the ID reconciliation module 2302 is not only capable of detecting and forwarding the device identifier associated with the ID device 2202 and the reader ID to the loyalty application determining module 2304, but is also capable of analyzing the received device identifier and determining if the device identifier should be passed directly to the loyalty application determining module 2304 in conjunction with the reader ID, or, if the device identifier needs to be interpreted and, for example, a derivative identifier forwarded to the loyalty application determining module. For example, the ID reconciliation module 2302 can analyze the device identifier and, since the loyalty module 2206 is aware of the environment of the reader 2204, recognize that a derivative or portion of the device identifier should be forwarded to the application determining module 2304. For example, if the ID device is a credit card, or in general any suitable device having an associated identifier, the ID reconciliation module could perform a look-up of the associated identifier and determine an appropriate derivative identifier that can be used in conjunction with the reader ID to determine the one or more appropriate loyalty applications. Thus, the system is not limited to use of specific identifiers associated with, for example, loyalty tags per se, but can be used in conjunction with any suitable device having an associated device identifier.

Likewise, the ID reconciliation module 2302 can perform a check to determine if the read device identifier is associated with a particular type of user, such as a subscribed user. For example, if a subscribed user is a member of a national gas station loyalty program, the one or more appropriate loyalty applications could be a loyalty application associated with the national chain of gas stations, a loyalty application associated with a particular product and/or a loyalty application associated with the particular store visited.

With the device identifier and reader ID, the loyalty application determining module 2304 is able to determine the one or more appropriate loyalty applications for the transaction. Specifically, for each loyalty application associated with the current transaction, the loyalty application determining module 2304 cooperates with the loyalty point update module 2306 to determine if different rewards should be allocated for different types of purchases. If different rewards are to be allocated for different types of purchases, the loyalty point update module 2306 cooperates with the reward determination module 2314 to determine if the reward is appropriate for each category of purchase. However, if different rewards are not available for different classes or categories of purchases, the reward determination module 2314 determines the award and the loyalty point update module 2306 updates one or more of an earned reward memory (not shown) on the ID device 2202, or an earned reward storage device (not shown) in the loyalty system 2200.

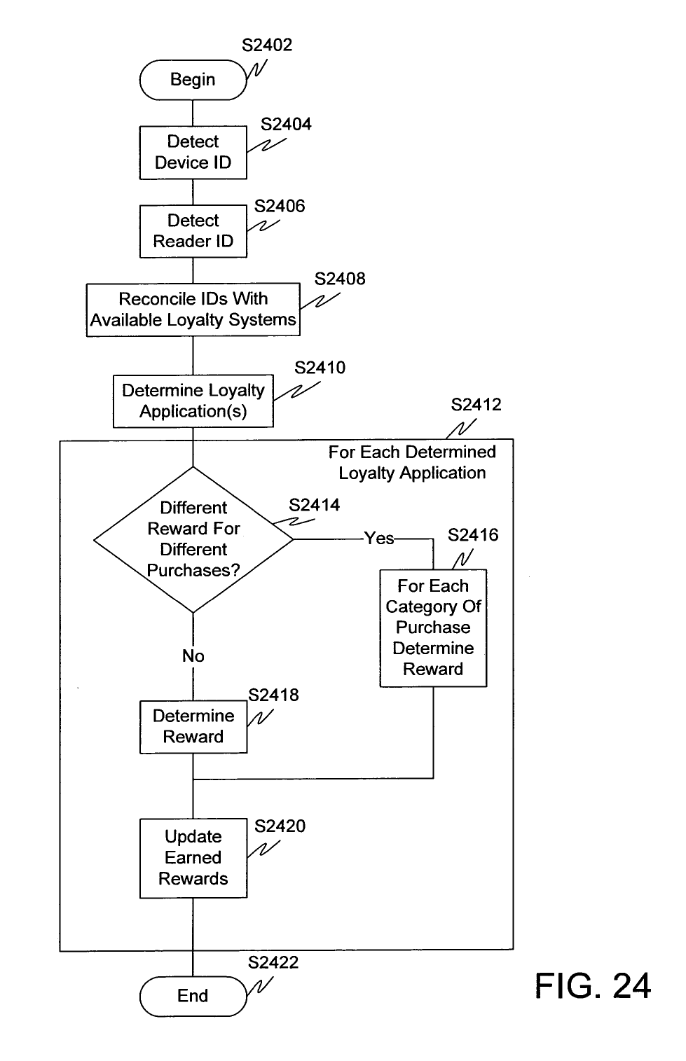

FIG. 24 outlines an exemplary method of the operation of a loyalty system. In particular, control begins in step S2402 and continues to step S2404. In step S2404, a device ID is detected. Next, in step S2406, a reader ID is detected. Then, in step S2408, the device identifier and reader ID are reconciled with available loyalty systems to determine if, for example, a derivative device identifier should be used and which loyalty system should be used. Control then continues to step S2410.

In step S2410, based on the detected device identifier and reader ID, one or more loyalty applications are determined. Then, in step S2412, for each determined loyalty application, a determination is made at step S2414 whether for the current loyalty application a different reward is awarded for different categories of purchases. If different awards are rewarded for different types, categories or classes of purchase, control continues to step S2416. Otherwise, control jumps to step S2418.

In step S2416, for each type, category or class of purchase, a reward can be determined. Control then continues to step S2420.

Alternatively, in step S2418, a reward for the current purchase is determined.

In step S2420, the earned rewards are updated, for example as discussed above, by storing the updated reward information on one or more of the ID device or in the loyalty system network. Control then continues to step S2422 where the control sequence ends.

Specifically, and as discussed above, loyalty systems traditionally reward customers for there loyalty based on purchases. Loyalty systems are typically point-based systems linked to dollars spent for a particular category or product. However, in many environments, several different categories or product are available for purchase. By dividing the purchase transaction information into one or more categories, the loyalty system is able to award loyalty rewards for one or more categories of sales. For example, typical loyalty mechanisms only have one type of reward system. By assigning different categories to different types or classes of products, the loyalty system is able to provide rewards for one or more categories of goods, or, alternatively, may combine one or more categories of goods for use in another type of loyalty reward program. As an example the following exemplary formulary based approaches can be used to determine rewards. However, in general, it should be appreciated that any suitable reward determination methodology can be used with equal success with the systems and method of this invention.

| | |
|---|---|
| Fuel Reward Point Determination | |
| X1 gallons = Y1 fuel points | Fuel reward factor = Y1/X1 or |
| X2 dollars of fuel = Y2 points | Fuel rewards factor = Y2/X2 |
| Non-Fuel Reward Point Determination | |
| X3 dollars of non-fuel = Y3 points | Non-Fuel reward factor = Y3/X3 |
| X4 dollars of category | Rewards factor = Y4/X4 |
| 1 item(s) = Y4 points | |
| Point Determination | |
| A items = B reward points | Reward factor = A/B |
| N Number of Items D and | Reward factor = (ND + NE)/F |
| E = F reward points | |
| C dollars (total transaction) = C1 points | Rewards factor = C1/C |

U.S. patent application Ser. No. 10/648,442, incorporated by reference herein, recognizes that one of the costs associated with implementing a new loyalty system is the initial capital required for the purchase of new equipment compatible with, for example, an existing point-of-sale system. Advantageously, the exemplary embodiments of U.S. patent application Ser. No. 10/648,442 can be used in conjunction with an existing retail or purchase transaction system, to provide coupons, points, rewards, advertising, custom content, and the like, for customers based on, for example, their loyalty, purchasing habits, and/or personal preferences. The exemplary system allows customers to interact with the loyalty system and existing purchase transaction system to claim, for example, coupons and/or rewards or to use the system to pay for a purchase.

Through the use of active and/or passive identification management translation capabilities, the exemplary system can be retrofitted into existing systems, such as retail point-of-sale systems, gas pumps, and the like, and can utilize already existing hardware, such as magnetic card readers, receipt printers, audio devices, video displays, multimedia displays, and the like, and can also take advantage of a customer's existing identification tag to be used as both a payment mechanism and loyalty system identifier.

In particular, a user is identified by a loyalty network through the use of an information storage device, such as an ID tag, that includes at least one code unique to the user, such as a customer. The code is linked to a customer profile identifying customer loyalty and preference data. A reader reads the code from the ID tag and forwards the tag information either through a tag reader provided with the retrofit loyalty device or by listening to devices already present in the system, such as a magnetic card reader.

The loyalty system is retrofitted into an existing retail or purchase transaction system, such that the system is inserted between a reading device and the reading device's associated original controlling hardware. The loyalty system is then capable of receiving information read by the reader and, for example, passively reading the data as if it is being transferred from the reader to the reader's controller or, actively reading the data and then determining if all, a portion, or derivative of that data should be transferred to the existing retail system. For example, this basic technology can be used to allow the loyalty system to accept, for example, information from an RFID tag, and submit magstripe data to a magstripe controller as if, for example, the magstripe reader had originally read the magstripe data.

Upon the customer identifying themselves to the loyalty system, the associated customer code is forwarded to a loyalty system that optionally interacts with the customer and determines one or more loyalty rewards and dispenses these rewards in accordance with, for example, inputs received from a user, a customer profile, and the like.

More specifically, once a customer has identified themselves to the loyalty device, the customer code is forwarded to, for example, a local loyalty server. The exemplary loyalty server passes the code on to a centralized loyalty host that uses the code to access the customer's loyalty and preference data, which may include information regarding which points, coupons, and loyalty rewards have been issued. The loyalty host then sends loyalty related information back to the local loyalty server, which, in coordination with the loyalty device, solicits customer input as to which coupons, rewards, or point allocations the customer would like to receive.

In addition, the loyalty device may interact with the customer through one of many methods, such as indicator lights indicating which inputs are available to be selected, a speaker outputting an audio message providing instruction as which inputs to use, a textual or video display showing which keys, or possibly touch screen locations, are active, and the like.

As will be appreciated, the tag and reader device can be any suitable of a wired or wireless radio frequency system, a direct-contact system, an optical system, and electro or electro-mechanical system, and the like. Wireless radio frequency systems are often referred to as RFID, which typically operate in the frequency range of 60 khz to 5.8 Ghz. Common commercially available tags operate at 900 Khz, 125 Khz, 13.56 Mhz and 2.4 Ghz. In addition to RFID, direct contact systems include, for example, smart card and magstripe readers, and optical systems, such as bar code readers and the like.

Likewise, the user's identification device can be integrated into a small device and, for example, attached to a keychain. Examples, of these devices are the TIRIS® RFID tag by Texas instruments, the MIFAIR® RFID tag by Phillips, OTI RFID tags, Dallas Semiconductor's I-Button, and smart cards, such as those produced by Schlumberger and barcodes, such as those found in many grocery store loyalty systems.

The exemplary embodiments of U.S. patent application Ser. No. 10/648,442 relate to a loyalty network, to providing a retrofit-capable loyalty system, to analyzing tag data and forwarding one or more of the tag data, a portion of the tag data, or a derivative portion of data to a loyalty system, to using a tag as an alternative payment mechanism, to providing an interactive loyalty network that is capable of immediately issuing to a customer loyalty rewards, and the like.

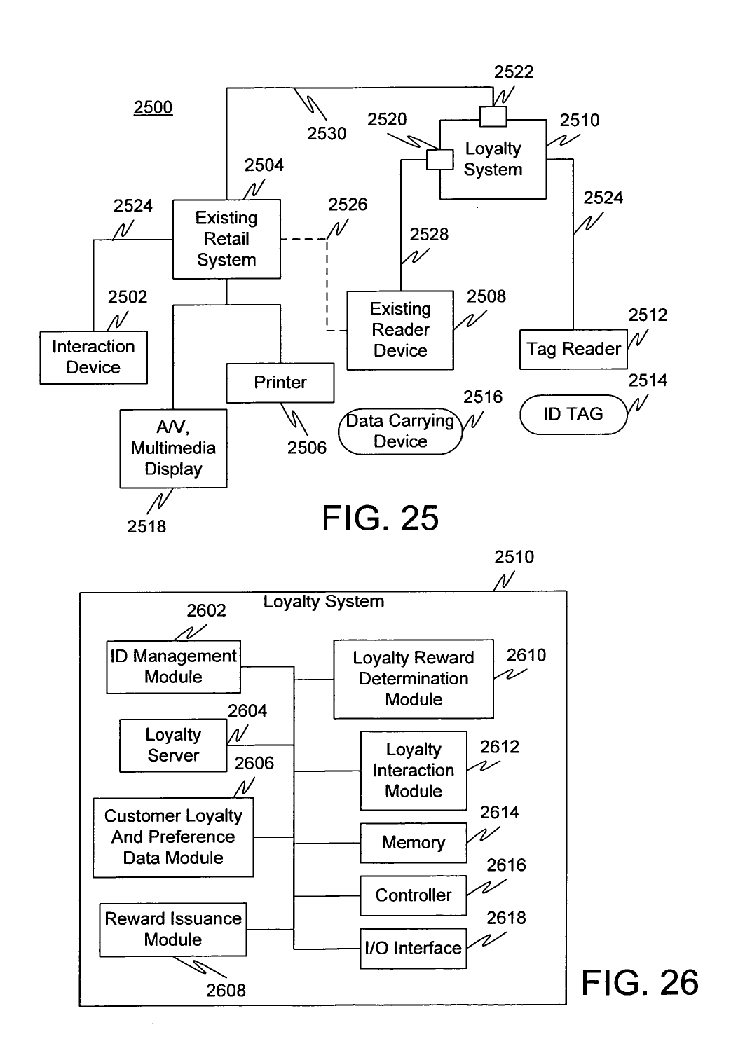

FIG. 25 illustrates an exemplary loyalty network 2500. In particularly, the loyalty network 2500 includes an interaction device 2502, an existing retail system 2504, a printer 2506, a audio, video and/or multimedia presentation device 2518, an exiting reader device 2508, a loyalty system 2510, a plurality of interface devices 2520 and 2522, and a tag reader 2512, all interconnected by links. Furthermore, the loyalty network 2500 includes one or more ID tags 2514, such as an RFID tag, and one or more data carrying devices 2516, such as a credit card.

In operation, the existing retail system 2504 that generally has attached devices, such as printer 2506, and existing reader device 2508, is retrofitted to the loyalty system 2510 and associated additional optional loyalty components. In particular, the loyalty system 2510 is adapted to communicate with the existing retail system 2504 as well as with one or more of the devices attached to the existing retail system 2504, such as the interaction device 2502, the existing reader device 2508, and one or more of the printer 2506, and audio, video, multimedia display 1518.

In accordance with an exemplary embodiment, the existing retail system 2504 is left essentially intact, with the existing retail system 2504 being connected to the interaction device 2502, the printer 2506, audio, video, multimedia display 2518, and the existing reader device 2508 via link 2526. Supplementing this existing interconnectivity, the loyalty system 2510 is connected via link 2530 to the existing retail system 2504.

In accordance with this exemplary embodiment, the loyalty system 2510 cooperates with the existing retail system 2504 to “listen in on” transaction information that is read by the existing reader device 2508 connected to the existing retail system 2504. Upon a customer introducing a data carrying device 2516 to the existing reader device 2508, the loyalty system 2510 correlates a portion of the data read from the data carrying device 2516, such as a credit card number, to a customer's loyalty identifier. The loyalty system 2510 then determines whether a loyalty reward is appropriate. If a loyalty reward is appropriate, the loyalty system 2510 can forward a notification of such to the user via, for example, the printer 2506, an audio, video or multimedia display 2518, and the like. In addition, or alternatively, the loyalty system 2510 can interact with the user, through the existing retail system 2504, and via the interaction device 2502, to further enhance the users experience by providing them with, for example, the option of immediately receiving the reward, receiving the reward at a later date, storing the reward, printing a coupon on printer 2506, and the like.

In an exemplary embodiment, the loyalty system 2510 can be interposed between and supplement the existing reader device 2508 and the existing retail system 2504. In particular, the existing reader device 2508 is connected via link 2528 and adapter 2520 to the loyalty system 2510. In turn, the loyalty system 2510 is connected via adaptor 2522 to the existing retail system 2504 via a link 2530. This allows, for example, as discussed hereinafter, the loyalty system 2510 to one or more of actively or passively regulate communications between the existing reader device 2508, the tag reader 2512, and the existing retail system 2504. For example, if the existing reader device 2508 is a magnetic stripe reader, the loyalty system 2510 can receive information associated with the magnetic stripe. The loyalty system can then one or more of forward this magnetic stripe information directly to the existing retail system 2504, translate this information into other data and/or correlate the read information with, for example, a customer ID that could be related to, for example, a customer ID on ID tag 2514 that could be associated with a customer loyalty profile.

Alternatively, for example, a customer is provided with the ability of using either the ID tag 2514 in conjunction with the tag reader 2512, or the data carrying device 2516 in conjunction with the existing reader device 2508 in order to identify themselves to the loyalty network 2500 so they are entitled to receive loyalty rewards.

Specifically, in operation, a user can introduce the ID tag 2514 into the sensible area of the tag reader 2512. At this time, an identifier on the tag 2514 is transferred via the tag read 2512 to the loyalty system 2510. The loyalty system 2510 can then one or more of forward the tag identifier, a derivative of the tag identifier or information associated with the tag identifier to the existing retail system 2504 that allows, for example, a transaction to purchase to occur in the traditional manner. For example, a credit card number can be derived from the tag identifier read by the tag reader 2512, for example by referencing a customer loyalty profile, and forwarded to the existing retail system for processing the purchasing portion of the transaction while the loyalty system monitors specifics regarding the transaction, such as amount spent, items purchased, categories of items purchased, historical transaction information, and the like, and determines any suitable appropriate loyalty rewards.

As discussed before, the loyalty system 2510 can also interact with a user via the interaction device 2502 and query them, for example, as to whether they would like to immediately receive, for example, a coupon on printer 2506, receive promotional advertising information via the audio, video, multimedia display 2518, check the status of earned rewards, view or hear content, such as a news feed, advertising, and the like.

FIG. 26 illustrates an exemplary embodiment of the loyalty system 2510 in greater detail. In particular, the loyalty system 2510 includes an ID management module 2602, a loyalty server 2604, a customer loyalty and preference data module 2606, a reward issuance module 2608, a loyalty reward determination module 2610, a loyalty interaction module 2612, a memory 2614, a controller 2616, and an I/O interface 2618. In operation, the ID management module 2602 receives from one or more of the existing reader device 2508 or tag reader 2512 data from an associated data carrying device that is capable of being read by the existing reader device 2508 or via the tag reader 2512. The ID management module 2602 interprets and manipulates this data, if necessary, depending on the particular installation and whether or not the data needs translation prior to being forwarded to the existing retail system 2504. For example, if the existing reader device 2508 reads data from a credit card, the loyalty system 2510, and in particular the ID management module 2602, could forward the credit card information via links 2528 and 2530 directly to the existing retail system 2504. Alternatively, the existing reader device 2508 can forward the credit card information, as was done prior to installation of the loyalty system 2510 to the existing retail system 2504 via link 2526. With either methodology, both the loyalty system 2510 and the existing retail system 2504 are capable of accessing the credit card information. With the credit card information, the loyalty system 2510 can correlate the credit card information to, for example, a particular user's loyalty identification. Then, as discussed above, the loyalty system 2510 can determine any suitable rewards, and the like, based on this user identification.

Alternatively, if the tag 2514 is introduced to the tag reader 2512, the ID management module 2602, upon receiving the identifier stored on tag 2514 can correlate the read identifier with, for example, a credit card number that could be forwarded to the existing retail system 2504 for processing of the purchase transaction.

Having received or determined a loyalty identifier for one or more of the tag 2514 and the data carrying device 2516, the loyalty server 2604, in conjunction of one or more of the memory 2614, controller 2616, I/O interface 2618, and customer loyalty and preference data module 2606 determines if, for example, the user is enrolled in a particular loyalty program(s) and whether the customer has loyalty or preference data associated with that enrolled program. For example, the loyalty and preference data can include historical information, such as past transactions, rewards earned, and the like, and the preference data can indicate, for example, whether the user likes to receive immediate notice of rewards earned, coupons based on rewards earned, information displayed, advertisements, and the like. Furthermore, the preference data can optionally include instructions that specify the loyalty system 2510 is to interact with the user via the interaction device 2502, such as a keypad, audio and/or video messaging device, touch screen, and the like, to determine in real-time or near real-time what a users preferences may be for the current transaction.

Assuming a user is a member of a loyalty program and entitled to a loyalty reward, the loyalty reward determination module 2610, in cooperation with one or more of the loyalty interaction module 2612 and reward issuance module 2608 determines a reward, if appropriate, and, as discussed above, based on preference data, one or more of issues to reward, updates stored reward information, or queries the customer, via interaction device 2502, for input as to how to handle the reward.

In addition, the loyalty interaction module 2612 need not be limited to specific transactions directed toward the consumption, receipt or acknowledgment of rewards, but can also be used to allow an existing retail system 2504 to have enhanced capabilities provided by the loyalty system 2510 via one or more of the interaction device 2502 and the printer 2506 and/or the audio, video or multimedia display 2518. For example, while a user may not be entitled to a particular loyalty reward based on a current transaction, the user may nevertheless like to receive certain content via one or more of the printer 2506 and audio/video multimedia display 2518. Thus, this content can be based on information stored in the preference data associated with the user, or, for example, provided to the user as selectable options at interaction device 100.

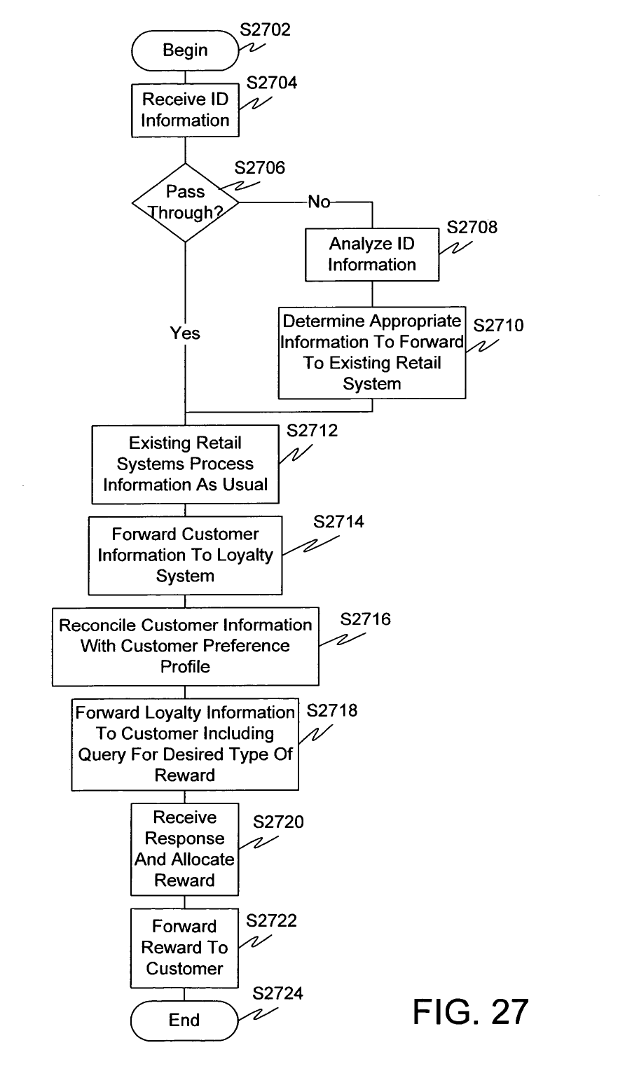

FIG. 27 outlines an exemplary method of operation for the loyalty network. In particular, control begins in step S2702 and continues to step S2704. In step S2704, identification information is received from one or more of a data carrying device or a tag. Next, in step S2706, a determination is made whether to pass the received identification information directly through to the existing retail system. If the identification information is to be passed directly through, control jumps to step S2712. Otherwise, control continues to step S2708. In step S2708, identification information is analyzed. Next, in step S2710, a determination is made as to which appropriate information should be forwarded to the existing retail system and the information forwarded thereto. Control then continues to step S2712.

In step S2712, the existing retail system processes the information as usual for, for example, the current sale transaction. Next, in step S2714, customer information is forwarded to the loyalty system. As discussed above, this customer information can be derived from the data stored on the ID tag or the data carrying device or, for example, can be the data on the data carrying devices themselves. Next, in step S2716, the customer information is reconciled with the customer preference profile. Then, in step S2718, the loyalty information is forwarded to the customer including, for example, queries asking the user how they would like reward, if any, handled. Control then continues to step S2720.

In step S2720, a response is optionally received from the user and an award allocated, stored, printed, and the like, and handled appropriately. Next, in step S2722, the reward, or a notification of how the reward was handled, is forwarded to the customer. Control then continues to step S2724 where the control sequence ends.

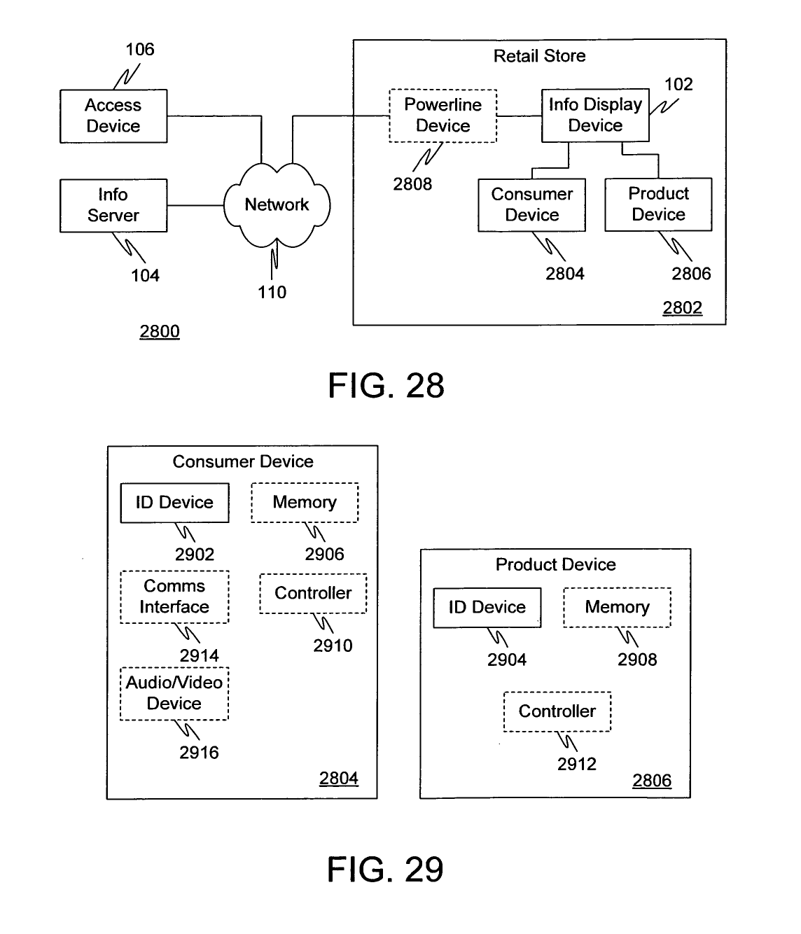

FIG. 28 is functional block diagram illustrating an exemplary loyalty network 2800 adapted for use in a retail store environment 2802 (e.g., a grocery store, a convenience store, a department store, a retail store, and the like). The exemplary system 2800 of the embodiment illustrated in FIG. 28 includes information server 104, network 110, access device 106, and information display device 102 shown FIG. 1 and discussed above. For the sake of brevity and clarity, the similar features shared by both embodiments illustrated in FIGS. 1 and 28 are shown with same numerical labels, and their descriptions are not repeated hereafter.

The exemplary system 2800 of FIG. 28, in addition to including the noted features of FIG. 1, also includes a powerline communications device 2808, as previously described, for connecting the information display device 102 to the information server 104, and the access device 10 via the network 110. The exemplary system 280 further includes a consumer device 2804, and a product device 2806. The consumer device 2804 can be used to identify a consumer to the information display device 102, and the product device 2806 can be used to identify a product to the information display device 102, for example, based on RFID, bar code, magnetic strips, and the like, technologies. Then, based on the consumer and/or product identified, a corresponding message, infomercial, product information, and the like, can be displayed to the consumer on the information display device 102.

Accordingly, the exemplary system 2800 can be used for delivering promotions to a consumer via the information display device 102, including sensing a product identification of a product selected by a consumer via the product device 2806, determining an identification uniquely associated with the consumer via the consumer device 2804, determining a promotion for delivery to the consumer based on the sensed product identification and the determined consumer identification via the information server 104 and/or the information display device 102, and delivering the determined promotion to the consumer via the information display device 102.

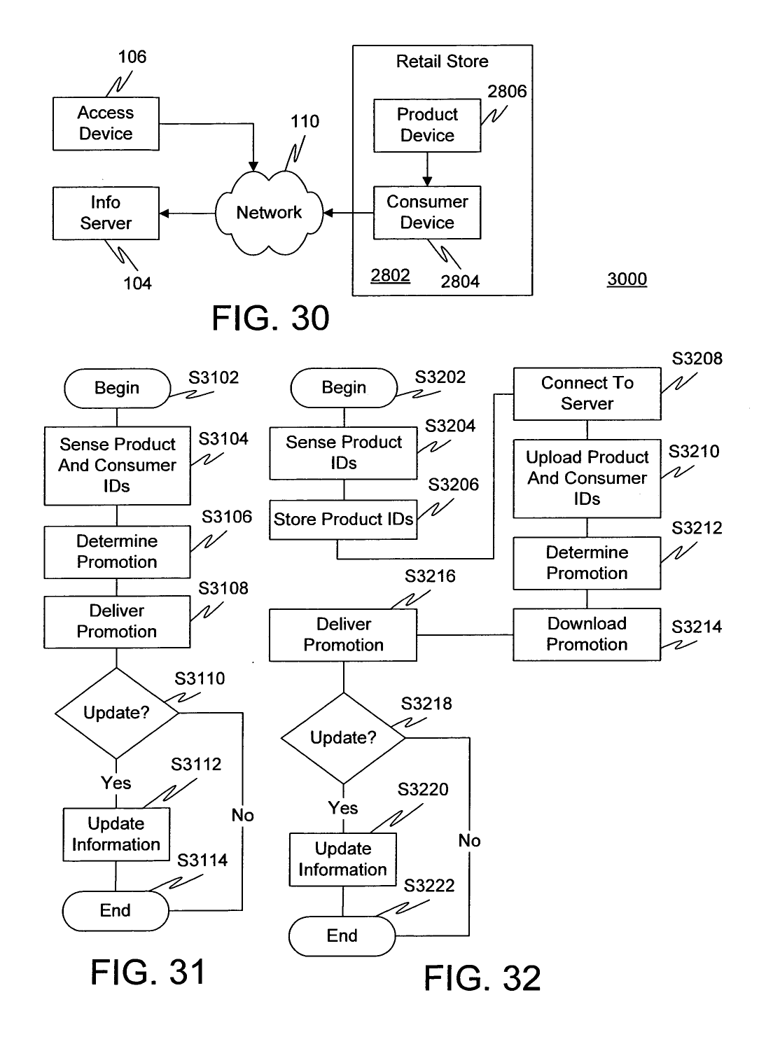

The sensing of the product can be based on sensing a barcode, RFID, and the like, including the product identification, on the product. In addition, as shown in FIG. 30, the sensing of the product can be performed directly on the consumer device 2804 and communicated to the information server, for example, via wireless communications, and the corresponding promotion can be delivered directly to the consumer device 2804, obviating the need for the information display device 102.

Similarly, determining the consumer identification can include sensing the consumer identification of the consumer, based on a barcode, RFID, and the like, including the consumer identification, on a card or device 2804 of the consumer. In addition, as shown in FIG. 30, the sensing of the consumer identification can be performed directly on the consumer device 2804 and communicated to the information server, for example, via wireless communications, and the corresponding promotion can be delivered directly to the consumer device 2804, obviating the need for the information display device 102.

In an exemplary embodiment, the promotion can be determined based on a purchasing history of the consumer, via the information server 104, as previously described. The purchasing history of the consumer can then be updated on the information server 104 based on the product identification and the consumer identification.

FIG. 29 illustrates exemplary consumer 2804 and product devices 2806 of FIG. 28, and which include identification devices 2902, and 2904, respectively, such as a bar code, magnetic strip, RFID, and the like, device for identifying the consumer, and the product, respectively. The consumer device 2804 can further include a wireless communications interface 2914 for directly communicating with the information server 104, and an audio/video display device 2916, a memory 2906, and controller 2904, for delivery of the promotions to the consumer, as with the embodiment of FIG. 30. Similarly, the product device 2806 can further include a memory 2908, and a controller 2912, as needed.

FIGS. 31- 32 are flowcharts outlining the exemplary operation of the loyalty network in a retail environment. In FIG. 31, processing begins at step S3102 and continues to step S3104, where the product and consumer IDs are sensed. At step S3106, a promotion is determined based on the product and/or consumer IDs. At step S3108, the promotion is delivered to the consumer. Step S3110 determines if any updating of information (e.g., profiles, histories, etc.) is necessary, and if so updates are performed at step S3112, and otherwise processing is completed at step S3114.

In FIG. 32, processing begins at step S3202 and continues to step S3204, where product IDs are sensed, and then stored at step S3206 on the consumer device 2804. The product IDs and the consumer ID are then transmitted to the information server 104 at steps S3208 and S3210. At step S3212, a promotion is determined based on the product and/or consumer IDs. At steps S3214 and S3216, the promotion is downloaded and delivered to the consumer. Step S3218 determines if any updating of information (e.g., profiles, histories, etc.) is necessary, and if so updates are performed at step S3220, and otherwise processing is completed at step S3222.

In the exemplary embodiment, the delivered promotions can include general or targeted commercials, infomercials, product information, audio and video files, MP3 files, music files, movie files, and the like. For example, based on an identified product and the consumer identification, a promotion regarding a competing product or a complementary product can be displayed to the consumer in the general or targeted manner. One or more of the information display devices 102 can be provided throughout the retail store 2802, for example, at end caps, on shopping carts, and the like.

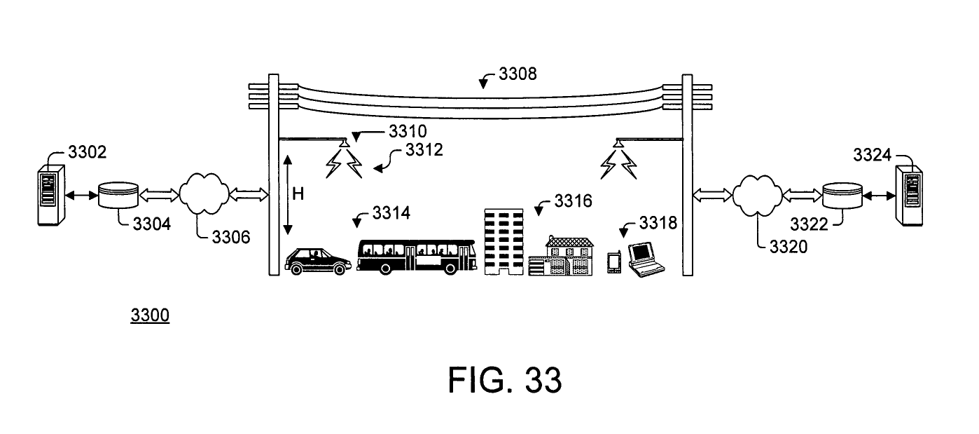

FIG. 33 is functional block diagram illustrating an exemplary lighting based communications network 3300 that can be employed with the exemplary embodiment of FIGS. 1-32. In FIG. 33, content servers 3302 and 3324, having respective content databases 3304 and 3322, can be connected, via communications networks 3306 and 3320, and adapted for delivery of content over power lines 3308, for example, using powerline communications, and the like.

In an exemplary embodiment, the content can be delivered to lighting fixture based wireless communication devices 3310, which in turn deliver the content via wireless links 3312 to vehicles 3314, buildings and houses 3316, devices 3318, and the like. Advantageously, the height and even distribution of the lighting fixture based wireless communication devices 3310 provide for an excellent means for the distribution of the content to the vehicles 3314, the buildings and houses 3316, the devices 3318, and the like.

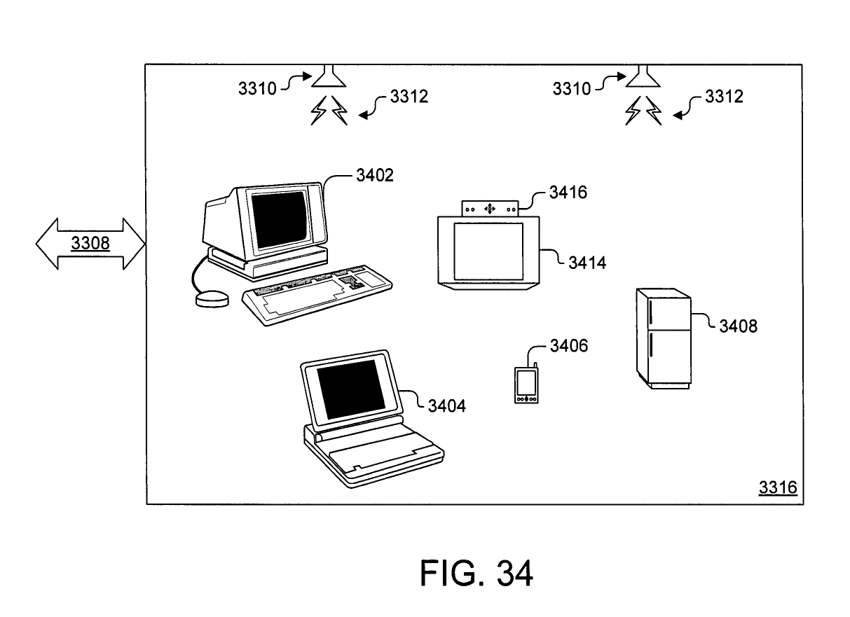

FIG. 34 illustrates exemplary devices of the lighting based communications network 3300 of FIG. 33. In FIG. 34, the buildings and houses 3316 can include lighting fixture based wireless communication devices 3310, which in turn deliver the content via wireless links 3312 to computer devices 3402, laptop devices 3404, appliance devices 3408, handheld devices 3406, television devices 3414, and set-top box devices 3416, and the like.

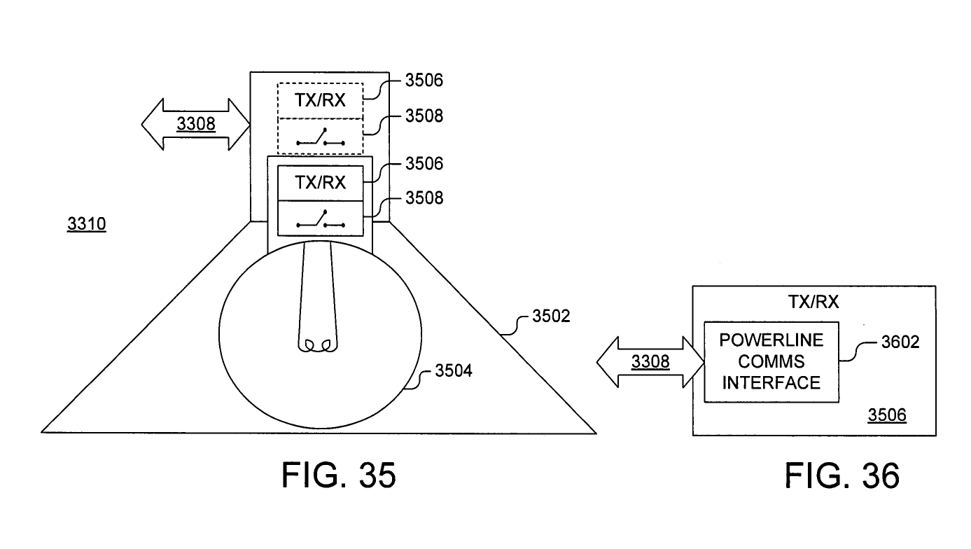

FIG. 35 is functional block diagram of an exemplary lighting based communications device 3310 of FIGS. 33-34. In FIG. 35, the lighting fixture based wireless communication device 3310 can include a wireless transmitter/receiver 3506 either integrated within the lighting fixture 3502 or as part of the light bulb 3504. A switch 3508 can be provided, advantageously, allowing for turning on and off the lighting fixture based wireless communication devices 3310, for example, over the Internet or wirelessly.

FIG. 36 is functional block diagram of further details of the lighting based communications device 3310 of FIG. 35. In FIG. 36, wireless transmitter/receiver 3506 can include a powerline communications interface 3602 for communicating over the power lines 3308.

The above-described systems and methods can be implemented on a loyalty system, a marketing system, an advertising system, in conjunction with an already existing customer loyalty system, in a point-of-purchase system, and the like, for example, included in a gas station, a retail store, a convenience store, and the like.

The exemplary embodiments described with respect to FIGS. 1-36 can be used in conjunction with each other, as will be appreciated by those skilled in the hardware and software arts. The above-described devices and subsystems of the exemplary embodiments can include, for example, any suitable servers, workstations, PCs, laptop computers, PDAs, Internet appliances, handheld devices, cellular telephones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the exemplary embodiments are for exemplary purposes, as many variations of the specific hardware used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

What is claimed:

1. An information presentation system for use within a gas station, the system comprising:
an identification sensor at the gas station and that senses an identification code on one or more identification-carrying devices;
an information server that receives at least the identification code and information presentation system identification information and determines one or more portions and type of information to be presented at an information presentation system at the gas station based on the identification code and the information presentation system identification information;
a printer at the gas station that receives and prints the one or more portions of information presented at the information presentation system; and
a template storage device that stores one or more templates that are combinable with the one or more portions of information.

2. The system of claim 1, wherein the information server is capable of determining the one or more portions of information independent of any sale transaction information.

3. The system of claim 1, wherein the information presentation system comprises a display device.

4. The system of claim 1, wherein the information presentation system comprises an audio device.

5. The system of claim 1, further comprising a profile storage device.

6. The system of claim 1, further comprising a history storage device.

7. The system of claim 1, further comprising a profile management device that cooperates with an access device to allow a user to manage a profile.

8. The system of claim 1, wherein the one or more portions of information are dynamically determined based on at least one of a loyalty program, a user history, a current transaction, a past transaction, and a user profile.

9. The system of claim 8, wherein the user profile comprises preferences governing the one or more portions of information to be printed at the printer.

10. The system of claim 1, wherein the one or more portions of information are dynamically determined upon receipt of the identification code at the information server.

11. The system of claim 1, wherein the identification sensor and the identification-carrying devices are one or more of a radio frequency identification tag and a radio frequency identification reader, an optical code and optical code reader, magnetic strip and magnetic strip reader and an inductive, capacitive or electrical identification-carrying device and associated inductive, capacitive or electrical sensor.

12. The system of claim 1, wherein one or more of a user profile and a user history are associated with the one or more identification-carrying devices.

13. The system of claim 1, wherein the information server is capable of servicing a plurality of information presentation systems for gas stations at geographically different locations.

14. The system of claim 1, wherein the identification sensor is located at a gas dispenser of the gas station.

15. The system of claim 1, wherein the information presentation system is located at a gas dispenser of the gas station.

16. The system of claim 1, wherein the information server uses the information presentation system identification information to aid in selecting the type of information to be presented.

17. The system of claim 1, wherein the information server reconciles the information presentation system identification information with a user profile associated with the identification code for selecting the type of information to be presented.

18. A method of presenting information for use within a gas station, the method comprising:
sensing at the gas station at least an identification code on one or more identification-carrying devices;
receiving at least the identification code and information presentation system identification information at an information server;
determining one or more portions and type of information to be presented on an information presentation system at the gas station based on the identification code and the information presentation system identification information;
receiving and printing at the gas station the one or more portions of information presented at the information presentation system; and
storing on a template storage device one or more templates that are combinable with the one or more portions of information.

19. The method of claim 18, wherein the information server is capable of determining the one or more portions of information independent of any sale transaction information.

20. The method of claim 18, further comprising presenting the one or more portions of information on a display device.

21. The method of claim 18, further comprising presenting the one or more portions of information on an audio device.

22. The method of claim 18, further comprising storing a user profile in a profile storage device.

23. The method of claim 18, further comprising storing a user history in a history storage device.

24. The method of claim 18, further comprising allowing a user to manage a user profile.

25. The method of claim 18, wherein the one or more portions of information are dynamically determined based on at least one of a loyalty program, a user history, a current transaction, a past transaction, and a user profile.

26. The method of claim 25, wherein the user profile comprises preferences governing the one or more portions of information to be printed at the printer.

27. The method of claim 18, wherein the one or more portions of information are dynamically determined upon receipt of the identification code at the information server.

28. The method of claim 18, wherein the identification sensor and the identification-carrying devices are one or more of a radio frequency identification tag and a radio frequency identification reader, an optical code and optical code reader, magnetic strip and magnetic strip reader and an inductive, capacitive or electrical identification-carrying device and associated inductive, capacitive or electrical sensor.

29. The method of claim 18, wherein one or more of a user profile and a user history are associated with the one or more identification-carrying devices.

30. The method of claim 18, wherein the information server is capable of servicing a plurality of information presentation systems for gas stations at geographically different locations.

31. The method of claim 18, wherein the identification sensor is located at a gas dispenser of the gas station.

32. The method of claim 18, wherein the information presentation system is located at a gas dispenser of the gas station.

33. The method of claim 18, wherein the information server uses the information presentation system identification information to aid in selecting the type of information to be presented.

34. The method of claim 18, wherein the information server reconciles the information presentation system identification information with a user profile associated with the identification code for selecting the type of information to be presented.

35. The method of claim 18, further comprising implementing the method with a computer system including one or more hardware and software devices configured to perform the steps of the method.

36. The method of claim 18, further comprising implementing the method with a computer readable medium including one or more computer readable instructions embedded therein and configured to cause one or more computer processors to perform the steps of the method.

37. A computer readable medium including one or more computer readable instructions embedded therein for presenting information for use within a gas station and configured to cause one or more computer processors to perform the steps of:
sensing at the gas station at least an identification code on one or more identification-carrying devices;
receiving at least the identification code and information presentation system identification information at an information server;
determining one or more portions and type of information to be presented on an information presentation system at the gas station based on the identification code and the information presentation system identification information;
receiving and printing at the gas station the one or more portions of information presented at the information presentation system; and
storing on a template storage device one or more templates that are combinable with the one or more portions of information.

38. The computer readable medium of claim 37, wherein the information server is capable of determining the one or more portions of information independent of any sale transaction information.

39. The computer readable medium of claim 37, further comprising one or more computer readable instructions configured to cause the one or more computer processors to perform the step of presenting the one or more portions of information on a display device.

40. The computer readable medium of claim 37, further comprising one or more computer readable instructions configured to cause the one or more computer processors to perform the step of presenting the one or more portions of information on an audio device.

41. The computer readable medium of claim 37, further comprising one or more computer readable instructions configured to cause the one or more computer processors to perform the step of storing a user profile in a profile storage device.

42. The computer readable medium of claim 37, further comprising one or more computer readable instructions configured to cause the one or more computer processors to perform the step of storing a user history in a history storage device.

43. The computer readable medium of claim 37, further comprising one or more computer readable instructions configured to cause the one or more computer processors to perform the step of allowing a user to manage a user profile.

44. The computer readable medium of claim 37, wherein the one or more portions of information are dynamically determined based on at least one of a loyalty program, a user history, a current transaction, a past transaction, and a user profile.

45. The method of claim 44, wherein the user profile comprises preferences governing the one or more portions of information to be printed at the printer.

46. The computer readable medium of claim 37, wherein the one or more portions of information are dynamically determined upon receipt of the identification code at the information server.

47. The computer readable medium of claim 37, wherein the identification sensor and the identification-carrying devices are one or more of a radio frequency identification tag and a radio frequency identification reader, an optical code and optical code reader, magnetic strip and magnetic strip reader and an inductive, capacitive or electrical identification-carrying device and associated inductive, capacitive or electrical sensor.

48. The computer readable medium of claim 37, wherein one or more of a user profile and a user history are associated with the one or more identification-carrying devices.

49. The computer readable medium of claim 37, wherein the information server is capable of servicing a plurality of information presentation systems for gas stations at geographically different locations.

50. The computer readable medium of claim 37, wherein the identification sensor is located at a gas dispenser of the gas station.

51. The computer readable medium of claim 37, wherein the information presentation system is located at a gas dispenser of the gas station.

52. The computer readable medium of claim 37, wherein the information server uses the information presentation system identification information to aid in selecting the type of information to be presented.

53. The computer readable medium of claim 37, wherein the information server reconciles the information presentation system identification information with a user profile associated with the identification code for selecting the type of information to be presented.
